(19) United States
(12) Patent Application Publication
(10) Pub. No.: US 2016/0255352 A1
(43) Pub. Date: Sep. 1, 2016

(54) PALETTE INDEX VALUE SWAPPING IN PALETTE MODE

(71) Applicant: QUALCOMM Incorporated, San Diego, CA (US)

(72) Inventors: Wei Pu, Pittsburgh, PA (US); Marta Karczewicz, San Diego, CA (US); Feng Zou, San Diego, CA (US); Rajan Laxman Joshi, San Diego, CA (US); Vadim Seregin, San Diego, CA (US); Joel Sole Rojals, San Diego, CA (US)

(21) Appl. No.: 15/152,244

(22) Filed: May 11, 2016

Related U.S. Application Data
(63) Continuation-in-part of application No. 14/875,486, filed on Oct. 5, 2015.
(60) Provisional application No. 62/159,822, filed on May 11, 2015.
(60) Provisional application No. 62/173,215, filed on Jun. 9, 2015.
(60) Provisional application No. 62/060,502, filed on Oct. 6, 2014.
(60) Provisional application No. 62/061,637, filed on Oct. 8, 2014.
(60) Provisional application No. 62/063,891, filed on Oct. 14, 2014.
(60) Provisional application No. 62/082,514, filed on Nov. 20, 2014.
(60) Provisional application No. 62/159,822, filed on May 11, 2015.
(60) Provisional application No. 62/173,215, filed on Jun. 9, 2015.

(51) Int. Cl. H04N 19/186; H04N 19/70; H04N 19/61; H04N 19/176

(52) U.S. Cl. CPC H04N 19/186; H04N 19/176; H04N 19/70; H04N 19/61

(57) ABSTRACT

In an example, a method of decoding video data using palette mode may include receiving, from an encoded video bitstream, a first syntax element defining a value indicative of a scan order. The method may include receiving, from the encoded video bitstream, a second syntax element defining a value indicative of a swap operation. The method may include reconstructing a palette block from a plurality of palette index values based on the value of the second syntax element indicative of the swap operation.

This application is a continuation-in-part of U.S. patent application Ser. No. 14/875,486 filed on Oct. 5, 2015 and claims the benefit of U.S. Provisional Patent Application No. 62/159,822 filed on May 11, 2015 and U.S. Provisional Patent Application No. 62/173,215 filed on Jun. 9, 2015, each of which is hereby incorporated by reference herein in its entirety. U.S. patent application Ser. No. 14/875,486 filed on Oct. 5, 2015 claims the benefit of U.S. Provisional Patent Application No. 62/060,502 filed on Oct. 6, 2014, U.S. Provisional Patent Application No. 62/061,637 filed on Oct. 8, 2014, U.S. Provisional Patent Application No. 62/063,891 filed on Oct. 14, 2014, U.S. Provisional Patent Application No. 62/082,514 filed on Nov. 20, 2014, U.S. Provisional Patent Application No. 62/159,822 filed on May 11, 2015, and U.S. Provisional Patent Application No. 62/173,215 filed on Jun. 9, 2015, each of which is hereby incorporated by reference herein in its entirety.

### TECHNICAL FIELD

This disclosure relates to video encoding and decoding, and more specifically, video encoding and decoding according to a palette-based coding mode.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicates the difference between the coded block and the predictive block. An intra-coded block is encoded according to an intra-coding mode and the residual data. For further compression, the residual data may be transformed from the pixel domain to a transform domain, resulting in residual coefficients, which then may be quantized. The quantized coefficients, initially arranged in a two-dimensional array, may be scanned in order to produce a one-dimensional vector of coefficients, and entropy coding may be applied to achieve even more compression.

Content, such as an image, may be encoded and decoded using palette mode. Generally, palette mode is a technique involving use of a palette to represent content. Content may be encoded such that the content is represented by an index map that includes values corresponding to the palette. The index map may be decoded to reconstruct the content.

### SUMMARY

Techniques of this disclosure relate to palette-based video coding. For example, in palette-based video coding, a video coder (e.g., a video encoder or video decoder) may form a “palette” as a table of colors for representing the video data of the particular area (e.g., a given block). Palette-based video coding may be especially useful for coding areas of video data having a relatively small number of colors. Rather than coding actual pixel values (or their residuals), the video coder may code palette indices for one or more of the pixels that relate the pixels with entries in the palette representing the colors of the pixels. The techniques described in this disclosure may include techniques for various combinations of one or more of signaling palette-based video coding modes, transmitting palettes, deriving palettes, deriving the value of non-transmitted syntax elements, and transmitting palette-based video coding maps and other syntax elements. For example, techniques of this disclosure may be directed to entropy coding palette information. As another example, techniques of this disclosure may be directed to swapping samples before or after processing the samples according to a scan order.

In one example, this disclosure describes a method comprising receiving, from an encoded video bitstream, a first syntax element defining a value indicative of a scan order; receiving, from the encoded video bitstream, a second syntax element defining a value indicative of a swap operation; and reconstructing a palette block from a plurality of palette index values based on the value of the second syntax element indicative of the swap operation.

In another example, this disclosure describes a device comprising a memory; and a video decoder configured to: receive, from an encoded video bitstream, a first syntax element defining a value indicative of a scan order; receive, from the encoded video bitstream, a second syntax element defining a value indicative of a swap operation; reconstruct a palette block from a plurality of palette index values based on the value of the second syntax element indicative of the swap operation; and store the palette block in the memory.

In another example, this disclosure describes an apparatus comprising means for receiving, from an encoded video bitstream, a first syntax element defining a value indicative of a scan order; means for receiving, from the encoded video bitstream, a second syntax element defining a value indicative of a swap operation; and means for reconstructing a palette block from a plurality of palette index values based on the value of the second syntax element indicative of the swap operation.

In another example, this disclosure describes a non-transitory computer-readable storage medium having instructions stored thereon that, when executed, cause one or more processors to receive, from an encoded video bitstream, a first syntax element defining a value indicative of a scan order; receive, from the encoded video bitstream, a second syntax element defining a value indicative of a swap operation; and reconstruct a palette block from a plurality of palette index values based on the value of the second syntax element indicative of the swap operation.

In another example, this disclosure describes a method comprising generating a first syntax element defining a value indicative of a scan order; generating a second syntax element defining a value indicative of a swap operation; and encoding a plurality of palette index values of a palette block based on the value of the second syntax element indicative of the swap operation.

In another example, this disclosure describes a device comprising a memory for storing a palette block; and a video encoder configured to: generate a first syntax element defining a value indicative of a scan order; generate a second syntax element defining a value indicative of a swap operation; and encode a plurality of palette index values of the palette block based on the value of the second syntax element indicative of the swap operation.

In another example, this disclosure describes an apparatus comprising means for generating a first syntax element defining a value indicative of a scan order; means for generating a second syntax element defining a value indicative of a swap operation; and means for encoding a plurality of palette index values of a palette block based on the value of the second syntax element indicative of the swap operation.

In another example, this disclosure describes a non-transitory computer-readable storage medium having instructions stored thereon that, when executed, cause one or more processors to generate a first syntax element defining a value indicative of a scan order; generate a second syntax element defining a value indicative of a swap operation; and encode a plurality of palette index values of a palette block based on the value of the second syntax element indicative of the swap operation.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video coding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a conceptual diagram illustrating an example of determining palette entries for palette-based video coding, consistent with techniques of this disclosure.

FIG. 5 is a conceptual diagram illustrating an example of determining indices to a palette for a block of pixels, consistent with techniques of this disclosure.

FIG. 6 is a conceptual diagram illustrating an example of determining maximum copy above run-length, assuming raster scanning order, consistent with techniques of this disclosure.

FIG. 7 is a conceptual diagram illustrating swapping samples in accordance with the techniques of this disclosure.

FIG. 8 is a conceptual diagram illustrating swapping a palette mode scan ordering before performing a traversal scan ordering in accordance with the techniques of this disclosure.

FIG. 9 is a conceptual diagram illustrating swapping samples of a block of samples, after traversing the samples, in accordance with the techniques of this disclosure.

FIG. 10 is a flowchart illustrating an example process for decoding video data consistent with techniques for palette-based video coding of this disclosure.

FIG. 11 is a flowchart illustrating an example process for encoding video data consistent with techniques for palette-based video coding of this disclosure.

### DETAILED DESCRIPTION

Aspects of this disclosure are directed to techniques for video coding and video data compression. In particular, this disclosure describes techniques for palette-based video coding of video data. In various examples of this disclosure, techniques of this disclosure may be directed to entropy coding palette information, such as a palette prediction vector (e.g., a binary palette prediction vector), and/or a palette prediction map using a form of Exponential Golomb code, as described in greater detail below.

In traditional video coding, images are assumed to be continuous-tone and spatially smooth. Based on these assumptions, various tools have been developed such as block-based transforms, filtering, and other coding tools, and such tools have shown good performance for natural content videos. However, in applications like remote desktop, collaborative work and wireless display, computer-generated screen content may be the dominant content to be compressed. This type of screen content tends to have discrete-tone, sharp lines, and high contrast object boundaries. The assumption of continuous-tone and smoothness may no longer apply, and thus, traditional video coding techniques may be inefficient in compressing content (e.g., screen content).

This disclosure describes palette-based video coding techniques, which may be particularly suitable for computer-generated screen content coding (e.g., screen content coding (SCC)) or other content where one or more traditional coding tools are inefficient. For example, assuming a particular area of video data has a relatively small number of colors. A video coder (e.g., a video encoder or video decoder) may code (i.e., encode or decode) a so-called “palette” as a table of colors for representing the video data of the particular area (e.g., a given block). Each pixel may be associated with an entry in the palette that represents the color of the pixel. For example, the video coder may code an index that relates the pixel value to the appropriate value in the palette.

The techniques for palette-based video coding of video data described in this disclosure may be used with one or more other coding techniques, such as techniques for inter- or intra-predictive coding. For example, as described in greater detail below, an encoder or decoder, or combined encoder-decoder (codec), may be configured to perform inter- and intra-predictive coding, as well as palette-based video coding.

In the palette-based video coding example above, a video encoder may encode a block of video data by determining a palette for the block, locating an entry in the palette to represent the value of one or more pixels, and encoding both the palette and one or more palette indices (also referred to as palette index values) that correspond to the pixels being coded by the palette. A video decoder may obtain, from an encoded bitstream, a palette for a block, as well as the one or more palette indices for the pixels of the block that are being coded by the pallet. The video decoder may relate the palette indices of the pixels to entries of the palette to reconstruct the pixel values of the block. Pixels (and/or related palette indices that indicate a pixel value) may generally be referred to as samples. The example above is intended provide a general description of palette-based video coding.

Recently, the design of a new video coding standard, namely High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). The screen content coding extension to HEVC, named SCC, is also being developed by the JCT-VC. A recent Working Draft (WD) of SCC (SCC WD) including palette mode description is available in JCTVC-R0348 “JCTVC-R0348_18_thMeetingFinalPaletteTextSpecification.doc”.

In some examples, the palette-based video coding techniques may be configured for use with one or more video coding standards. Example video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC). High Efficiency Video Coding (HEVC) is a new video coding standard developed by the Joint Collaboration Team on Video Coding (JCT-VC) of ITU-T Video Coding Experts Group (VCEG) and ISO/IEC Motion Picture Experts Group (MPEG). A recent HEVC text specification draft is described in Bross et al., “High Efficiency Video Coding (HEVC) Text Specification Draft 10 (for FDIS & Consent),” JCVC-L1003_v13, 12^{th} Meeting of JCT-VC of ITU-T SG16 WP 3 and ISO/IEC JCT 1/SC 29/WG 11, 14-23 Jan. 2013 (“HEVC Draft 10”), available from: http://phenix.int-evey.fr/jct/doc_end_user/documents/12_Geneva/wg11/JCTVC-L1003-v13.zip. As of Oct. 5, 2015, version 3 of the final draft of HEVC dated April 2015 is available at http://www.itu.int/rec/T-REC-H.265-201504-I.

Recently, the design of HEVC has been finalized by the Joint Collaboration Team on Video Coding (JCT-VC) of ITU-T Video Coding Experts Group (VCEG) and ISO/IEC Motion Picture Experts Group (MPEG). The latest HEVC specification, referred to as HEVC Version 1 hereinafter, is described in “ITU-T H.265 (V1),” which as of Oct. 5, 2015 is available from http://www.itu.int/ITU-T/recommendations/rec.aspx?rec=11885&lang=en. Document ITU-T H.265, SERIES H: AUDIOVISUAL AND MULTIMEDIA SYSTEMS, Infrastructure of Audiovisual Services—Coding of Moving Video, “High Efficiency Video Coding,” April 2013 also describes the HEVC standard. A recent specification of Range extensions, referred to as RExt hereinafter, is described in “ITU-T H.265 (V3),” which as of Oct. 5, 2015 is available from http://www.itu.int/ITU-T/recommendations/rec.aspx?rec=12455&lang=en.

With respect to the HEVC framework, as an example, the palette-based video coding techniques of this disclosure may be configured to be used at a coding unit (CU) level. In other examples for HEVC, the palette-based video coding techniques of this disclosure may be configured to be used at the prediction unit (PU) level. In other examples for HEVC, the palette-based video coding techniques of this disclosure may be configured to be used at the sub-prediction unit (sub-PU) level (e.g., a sub-block of a prediction unit). Accordingly, all of the following disclosed processes described in the context of a CU level may, additionally or alternatively, apply to a PU level or a sub-PU level. However, these HEVC-based examples should not be considered a restriction or limitation of the palette-based video coding techniques described herein, as such techniques may be applied to work independently or as part of other existing or yet to be developed systems/standards. In these cases, the unit for palette coding can be square blocks, rectangular blocks or even regions of non-rectangular shape.

Samples in a block of video data may be processed (e.g., scanned) using a horizontal raster scanning order or other scanning order. For example, the video encoder may convert a two-dimensional block of palette indices into a one-dimensional array by scanning the palette indices using a horizontal raster scanning order. Likewise, the video decoder may reconstruct a block of palette indices using the horizontal raster scanning order. Accordingly, this disclosure may refer to a previous sample as a sample that precedes the sample currently being coded in the block in the scanning order. It should be appreciated that scans other than a horizontal raster scan, such as vertical raster scanning order, may also be applicable. The example above, as well as other examples set forth in this disclosure, is intended to provide a general description of palette-based video coding.

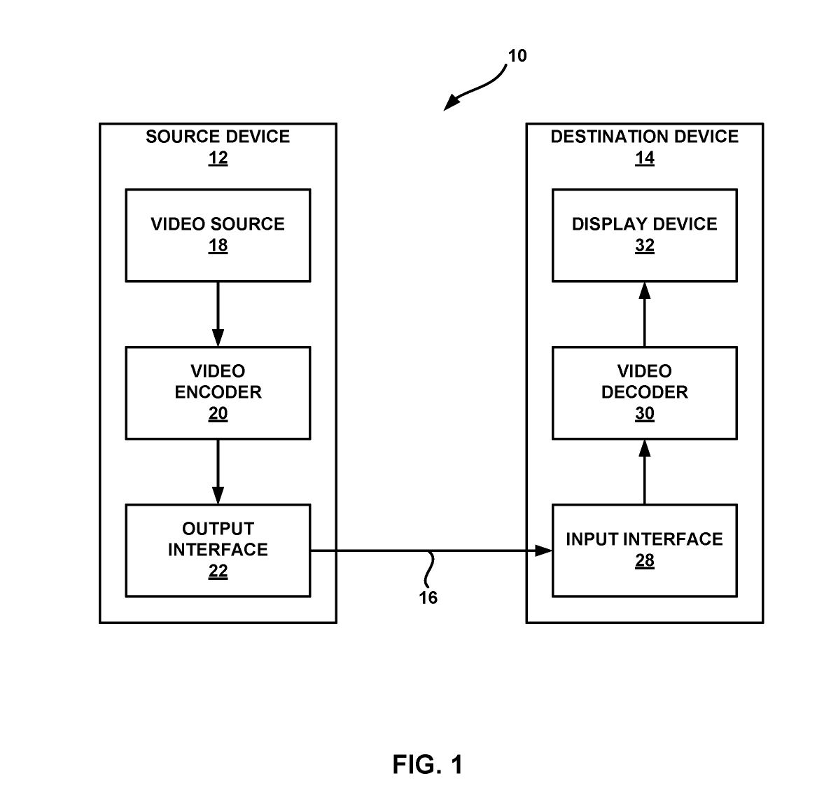

FIG. 1 is a block diagram illustrating an example video coding system 10 that may utilize the techniques of this disclosure. As used herein, the term “video coder” refers generically to both video encoders and video decoders. In this disclosure, the terms “video coding” or “coding” may refer generically to video encoding or video decoding. Video encoder 20 and video decoder 30 of video coding system 10 represent examples of devices that may be configured to perform techniques for palette-based video coding in accordance with various examples described in this disclosure. For example, video encoder 20 and video decoder 30 may be configured to selectively code various blocks of video data, such as CUs or PUs in HEVC coding, using either palette-based coding or non-palette based coding. Non-palette based coding modes may refer to various inter-predictive temporal coding modes or intra-predictive spatial coding modes, such as the various coding modes specified by HEVC Draft 10.

As shown in FIG. 1, video coding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses. Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like.

Destination device 14 may receive encoded video data from source device 12 via a channel 16. Channel 16 may comprise one or more media or devices capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). The one or more communication media may include routers, switches, base stations, or other equipment that facilitate communication from source device 12 to destination device 14.

In another example, channel 16 may include a storage medium that stores encoded video data generated by source device 12. In this example, destination device 14 may access the storage medium, e.g., via disk access or card access. The storage medium may include a variety of locally-accessed data storage media such as Blu-ray discs, DVDs, CD-ROMs, flash memory, or other suitable digital storage media for storing encoded video data.

In a further example, channel 16 may include a file server or another intermediate storage device that stores encoded video data generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

Source device 12 and destination device 14 may be configured to perform palette-based coding consistent with this disclosure. The techniques of this disclosure for palette-based video coding, however, are not limited to wireless applications or settings. The techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video coding system 10 may be configured to support one-way or two-way video transmission to support applications such as video streaming, video playback, video broadcasting, and/or video telephony.

Video coding system 10 illustrated in FIG. 1 is merely an example and the techniques of this disclosure may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In many examples, the encoding and decoding is performed by devices that do not communicate with one another, but simply encode data to memory and/or retrieve and decode data from memory.

In the example of FIG. 1, source device 12 includes a video source 18, a video encoder 20, and an output interface 22. In some examples, output interface 22 may include a modulator/demodulator (modem) and/or a transmitter. Video source 18 may include a video capture device, e.g., a video camera, a video archive containing previously-captured video data, a video feed interface to receive video data from a video content provider, and/or a computer graphics system for generating video data, or a combination of such sources of video data.

Video encoder 20 may encode video data from video source 18. In some examples, source device 12 directly transmits the encoded video data to destination device 14 via output interface 22. In other examples, the encoded video data may also be stored onto a storage medium or a file server for later access by destination device 14 for decoding and/or playback.

In the example of FIG. 1, destination device 14 includes an input interface 28, a video decoder 30, and a display device 32. In some examples, input interface 28 includes a receiver and/or a modem. Input interface 28 may receive encoded video data over channel 16. Display device 32 may be integrated with or may be external to destination device 14. In general, display device 32 displays decoded video data. Display device 32 may comprise a variety of display devices, such as a liquid crystal display (LCD), a plasma display, an organic light emitting diode (OLED) display, or another type of display device.

Video encoder 20 and video decoder 30 each may be implemented as any of a variety of suitable circuitry, such as one or more microprocessors, digital signal processors (DSPs), application-specific integrated circuits (ASICs), field-programmable gate arrays (FPGAs), discrete logic, hardware, or any combinations thereof. If the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” or “transmitting” certain information to another device, such as video decoder 30. The term “signaling” or “transmitting” may generally refer to the communication of syntax elements and/or other data used to decode the compressed video data. Such communication may occur in real- or near-real-time. Alternately, such communication may occur over a span of time, such as might occur when storing syntax elements to a computer-readable storage medium in an encoded bitstream at the time of encoding, which then may be retrieved by a decoding device at any time after being stored to this medium.

In some examples, video encoder 20 and video decoder 30 operate according to a video compression standard, such as HEVC standard mentioned above, and described in HEVC Draft 10. Version 3 of the final draft of HEVC dated April 2015 is available at http://www.itu.int/rec/T-REC-H.265-201504-I. In addition to the base HEVC standard, there are ongoing efforts to produce scalable video coding, multiview video coding, and 3D coding extensions for HEVC. In addition, palette-based coding modes, e.g., as described in this disclosure, may be provided for extension of the HEVC standard. In some examples, the techniques described in this disclosure for palette-based coding may be applied to encoders and decoders configured to operation according to other video coding standards, such as the ITU-T-H.264/AVC standard or future standards. Accordingly, application of a palette-based coding mode for coding of coding units (CUs) or prediction units (PUs) in an HEVC codec is described for purposes of example.

In HEVC and other video coding standards, a video sequence typically includes a series of pictures. Pictures may also be referred to as “frames.” A picture may include three sample arrays, denoted S_{L}, S_{Cb} and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may be a coding tree block of luma samples, two corresponding coding tree blocks of chroma samples, and syntax structures used to code the samples of the coding tree blocks. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). In monochrome pictures or pictures having three separate color planes, a CU may comprise a single coding block and syntax structures used to code the samples of the coding block. A slice may include an integer number of CTUs ordered consecutively in the raster scan.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may be a coding block of luma samples and two corresponding coding blocks of chroma samples of a picture that has a luma sample array, a Cb sample array and a Cr sample array, and syntax structures used to code the samples of the coding blocks. Video encoder 20 may partition a coding block of a CU into one or more prediction blocks. A prediction block may be a rectangular (i.e., square or non-square) block of samples on which the same prediction is applied. A prediction unit (PU) of a CU may be a prediction block of luma samples, two corresponding prediction blocks of chroma samples of a picture, and syntax structures used to predict the prediction block samples. Video encoder 20 may generate predictive luma, Cb and Cr blocks for luma, Cb and Cr prediction blocks of each PU of the CU. In monochrome pictures or pictures having three separate color planes, a PU may comprise a single prediction block and syntax structures used to predict the prediction block.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU.

If video encoder 20 uses inter prediction to generate the predictive blocks of a PU, video encoder 20 may generate the predictive blocks of the PU based on decoded samples of one or more pictures other than the picture associated with the PU. Video encoder 20 may use uni-prediction or bi-prediction to generate the predictive blocks of a PU. When video encoder 20 uses uni-prediction to generate the predictive blocks for a PU, the PU may have a single motion vector (MV). When video encoder 20 uses bi-prediction to generate the predictive blocks for a PU, the PU may have two MVs.

After video encoder 20 generates predictive luma, Cb and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb and Cr residual blocks of a CU into one or more luma, Cb and Cr transform blocks. A transform block may be a rectangular block of samples on which the same transform is applied. A transform unit (TU) of a CU may be a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encoding syntax elements indicating the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bitstream.

Video encoder 20 may output a bitstream that includes the entropy-encoded syntax elements. The bitstream may include a sequence of bits that forms a representation of coded pictures and associated data. The bitstream may comprise a sequence of network abstraction layer (NAL) units. Each of the NAL units includes a NAL unit header and encapsulates a raw byte sequence payload (RBSP). The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a picture parameter set (PPS), a second type of NAL unit may encapsulate an RBSP for a coded slice, a third type of NAL unit may encapsulate an RBSP for SEI, and so on. NAL units that encapsulate RBSPs for video coding data (as opposed to RBSPs for parameter sets and SEI messages) may be referred to as video coding layer (VCL) NAL units.

Video decoder 30 may receive a bitstream generated by video encoder 20. In addition, video decoder 30 may parse the bitstream to decode syntax elements from the bitstream. Video decoder 30 may reconstruct the pictures of the video data based at least in part on the syntax elements decoded from the bitstream. The process to reconstruct the video data may be generally reciprocal to the process performed by video encoder 20. For instance, video decoder 30 may use MVs of PUs to determine predictive blocks for the PUs of a current CU. In addition, video decoder 30 may inverse quantize transform coefficient blocks associated with TUs of the current CU. Video decoder 30 may perform inverse transforms on the transform coefficient blocks to reconstruct transform blocks associated with the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

In some examples, video encoder 20 and video decoder 30 may be configured to perform palette-based coding. For example, in palette based coding, rather than performing the intra-predictive or inter-predictive coding techniques described above, video encoder 20 and video decoder 30 may code a so-called palette as a table of colors for representing the video data of the particular area (e.g., a given block). Each pixel may be associated with an entry in the palette that represents the color of the pixel. For example, video encoder 20 and video decoder 30 may code an index that relates the pixel value to the appropriate value in the palette.

In the example of palette-based coding, video encoder 20 may encode a block of video data by determining a palette for the block, locating an entry in the palette to represent the value of each pixel, and encoding the palette and the index values for the pixels relating the pixel value to the palette. Video decoder 30 may obtain, from an encoded bitstream, a palette for a block, as well as index values for the pixels of the block. Video decoder 30 may relate the index values of the pixels to entries of the palette to reconstruct the pixel values of the block.

Using the palette, video encoder 20 and/or video decoder 30 may be configured to map a block of samples into an index block. Run-length based entropy coding may be used to compress the index block. The run-length syntax element, i.e., palette_run, in the screen content coding working draft, R. Joshi and J. Xu, “High efficient video coding (HEVC) screen content coding: Draft 1,” Joint Collaborative Team on Video Coding (JCT-VC) of ITU-T SG 16 WP 3 and ISO/IEC JTC 1/SC 29/WG 11 18th Meeting: Sapporo, JP, 30 Jun.-9 Jul. 2014 (JCTVC-R1005), may be coded in accordance with one or more techniques described herein.

A stated above, in an example palette-coding mode, a palette may include entries numbered by an index. Each may entry may represent color component values or intensities (for example, in color spaces such as RGB, YUV, CMYK, or other formats), which can be used as predictor for a block or as final reconstructed block samples. As described in standard submission document JCTVC-Q0094 (Wei Pu et al., “AHG10: Suggested Software for Palette Coding based on RExt6.0,” JCTVC-Q0094, Valencia, ES, 27 Mar.-4 Apr. 2014) a palette may include entries that are copied from a predictor palette. A predictor palette may include palette entries from blocks previously coded using palette mode or other reconstructed samples. For each entry in the predictor palette, a binary flag is sent to indicate whether that entry is copied to the current palette (indicated by flag=1). This is referred to as the binary palette prediction vector. Additionally the current palette may comprise (e.g., consist of) new entries signaled explicitly. The number of new entries may be signaled as well.

As another example, in palette mode, a palette may include entries numbered by an index representing color component values that may be used as predictors for block samples or as final reconstructed block samples. Each entry in the palette may contain, for example, one color component (e.g., luma value), two components (e.g., two chroma values), or three color components (e.g., RGB, YUV, etc.). Previously decoded palette entries may be stored in a list. This list may be used to predict palette entries in the current palette mode CU, for example. A binary prediction vector may be signaled in the bitstream to indicate which entries in the list are re-used in the current palette. In some examples, run-length coding may be used to compress the binary palate predictor. For example, a run-length value may be coded using 0th order Exp-Golomb code.

In this disclosure, it will be assumed that each palette entry specifies the values for all color components of a sample. However, the concepts of this disclosure are applicable to using a separate palette and/or a separate palette entry for each color component. Also, it is assumed that samples in a block are processed using horizontal raster scanning order. However, other scans such as vertical raster scanning order are also applicable. As mentioned above, a palette may contain predicted palette entries, for example, predicted from the palette(s) used to code the previous block(s), and the new entries which may be specific for the current block and are signaled explicitly. The encoder and decoder may know the number of the predicted and new palette entries and a sum of them may indicate the total palette size in a block.

As proposed in the example of JCTVC-Q0094 cited above, each sample in a block coded with the palette may belong to one of the three modes, as set forth below:
Escape mode. In this mode, the sample value is not included into a palette as a palette entry and the quantized sample value is signaled explicitly for all color components. It is similar to the signaling of the new palette entries, although for new palette entries, the color component values are not quantized.
CopyFromTop mode (also called copy above mode). In this mode, the palette entry index for the current sample is copied from the sample located directly above in a block. In other examples, for copy above mode, a block of video data may be transposed so that the sample above the block is actually the sample to the left of the block.
Value mode (also called index mode). In this mode, the value of the palette entry index is explicitly signaled.

As described herein, a palette entry index may be referred as a palette index or simply index. These terms can be used interchangeably to describe techniques of this disclosure. In addition, as described in greater detail below, a palette index may have one or more associated color or intensity values. For example, a palette index may have a single associated color or intensity value associated with a single color or intensity component of a pixel (e.g., an Red component of RGB data, a Y component of YUV data, or the like). In another example, a palette index may have multiple associated color or intensity values. In some instances, palette-based video coding may be applied to code monochrome video. Accordingly, “color value” may generally refer to any color or non-color component used to generate a pixel value.

For CopyFromTop and Value modes, a run value may be signaled as well. In this disclosure, the run value may be referred to simply as “run.” Signaling index and run value is somewhat similar to Run-Length Coding. The run specifies the number of subsequent samples that belong to the same mode. For example, if consecutive indices are 0, 2, 2, 2, 2, 5, for the second sample, a Value mode may be signaled. After signaling the index equal to 2 in the example above, a run of 3 is signaled signifying that the 3 subsequent samples also have the same index (2). Similarly, a run of 4 following CopyFromTop mode means that a total of 5 indices are copied from the corresponding indices above.

A run value may indicate a run of palette indices that are coded using the same palette-coding mode. For example, with respect to Value mode, a video coder (a video encoder or video decoder) may code a palette index (also referred to as a palette index value or simply index value) and a run value that indicates a number of consecutive samples in a scan order that have the same palette index and that are being coded with the palette index. With respect to CopyFromTop mode, the video coder may code an indication that an index for the current sample value is copied based on an index of an above-neighboring sample (e.g., a sample that is positioned above the sample currently being coded in a block) and a run value that indicates a number of consecutive samples in a scan order that also copy a palette index from an above-neighboring sample and that are being coded with the palette index. Accordingly, in the examples above, a run of palette indices refers to a run of palette indices having the same value or a run of palette indices that are copied from above-neighboring palette indices.

Hence, the run may specify, for a given mode, the number of subsequent samples that belong to the same mode. In some instances, signaling an index and a run value may be similar to run-length coding. In an example for purposes of illustration, a string of consecutive palette indices of a block may be 0, 2, 2, 2, 2, 5 (e.g., where each index corresponds to a sample in the block). In this example, a video coder may code the second sample (e.g., the first palette index value of two) using Value mode. After coding an index value that is equal to 2, the video coder may code a run of three, which indicates that the three subsequent samples also have the same palette index value of two. In a similar manner, coding a run of four palette indices after coding an index using CopyFromTop mode may indicate that a total of five palette indices are copied from the corresponding palette indices in the row above the sample position currently being coded.

The techniques described in this disclosure may include techniques for various combinations of one or more of signaling palette-based video coding modes, transmitting palettes, deriving palettes, signaling scanning order, deriving scanning order, and transmitting palette-based video coding maps and other syntax elements. For example, techniques of this disclosure may be directed to entropy coding palette information. In some examples, the techniques of this disclosure may, among other things, be used to increase coding efficiency and reduce coding inefficiencies associated with palette-based video coding. Accordingly, as described in greater detail below, the techniques of this disclosure may, in some instances, improve efficiency and improve bitrate when coding video data using a palette mode.

In a third screen content coding core experiment, subtest B.6, as described in document JCTVC-Q1123 (Yu-Wen Huang et al., “Description of Screen Content Core Experiment 3 (SCCE3): Palette Mode,” JCTVC-Q1123, Valencia, ES, 27 Mar.-4 Apr. 2014), another mode was introduced into the software released by Canon on 26^{th} May 2014. The macro for this mode was “CANON_NEW_RUN_LAST_TRANSITION.” This mode may be similar to value mode in that it comprises (e.g., consists of) an index value followed by a run specifying the number of subsequent samples which have the same palette index. A difference between value mode and the new mode (referred to as Transition Run) is that the index value of the transition run mode is not signaled. Rather, the index value is inferred. For instance, a video decoder may infer the index value. The inferred index will be referred to as a transition index.

There may be two or more distinct ways of signaling the modes. In JCTVC-Q0094, if the macro “PLT_REMOVE_ESCAPE_FLAG” is 0, an escape flag is signaled explicitly to indicate whether a sample in a block is coded in the escape mode. If the sample is not coded with the escape mode, an SPoint flag is signaled to indicate whether the mode is CopyFromTop or Value. The escape flag (e.g., “PLT_REMOVE_ESCAPE_FLAG”) and the SPoint flag (when necessary) are not signaled for the subsequent run samples, and the values of those flags are inferred for all the samples included into the run. This method will be referred to as explicit escape method.

If the macro “PLT_REMOVE_ESCAPE_FLAG” is set to 1, the number of palette entries is increased by one and a special index (for example, the last palette index in the increased palette) is used as an indication of the escape mode. Such a technique may be referred to as an implicit escape technique. In this case, there are only two possible modes: CopyFromTop or Value. Thus, only SPoint flag is signaled. If a sample is coded in the Value mode and an index is equal to the escape index, the sample is inferred to be coded in the escape mode. In this case no run is signaled. In some examples, a run indicating a number of consecutive escape indices may also be signaled.

The techniques for palette-based coding of video data may be used with one or more other coding techniques, such as techniques for inter- or intra-predictive coding. For example, as described in greater detail below, an encoder or decoder, or combined encoder-decoder (codec), may be configured to perform inter- and intra-predictive coding, as well as palette-based coding.

In some examples, video encoder 20 may encode one or more syntax elements indicating a number of consecutive pixels in a given scan order that have the same pixel value. The string of like-valued pixel values may be referred to herein as a “run.” In an example for purposes of illustration, if two consecutive pixels in a given scan order have different values, the run is equal to zero. If two consecutive pixels in a given scan order have the same value but the third pixel in the scan order has a different value, the run is equal to one. Video decoder 30 may obtain the syntax elements indicating a run from an encoded bitstream and use the data to determine the number of consecutive pixel locations that have the same index value.

In some examples, video encoder 20 and video decoder 30 may perform line copying for one or more entries of a map. For example, video encoder 20 may indicate that a pixel value for a particular entry in a map is equal to an entry in a line above the particular entry. Video encoder 20 may also indicate, as a run, the number of indices in the scan order that are equal to the entry in the line above of the particular entry. In this example, video encoder 20 and or video decoder 30 may copy index values from the specified neighboring line and from the specified number of entries for the line of the map currently being coded.

In some examples, video encoder 20 and video decoder 30 may predict one or more entries of a current palette based one or more palettes used for previously coded blocks. Video encoder 20 and/or video decoder 30 may, in some instances, generate a list of palette predictors (e.g., palette entries used to code other blocks). Video encoder 20 and/or video decoder 30 may code a binary palette prediction vector to indicate which entries of the list of predictors are used for a palette of a current block.

According to aspects of this disclosure, as described in greater detail below, video encoder 20 and video decoder 30 may be configured to entropy code palette information using a type of variable length coding referred to as k^{th} order truncated Exponential-Golomb coding (TEGk). Video encoder 20 and video decoder 30 may code a binary palette prediction vector in a coded video bitstream. The binary palette prediction vector indicates which indices from the palette list are used to predict palette entries for a CU, using TEGk. The palette comprises palette values of one or more previously-coded blocks. Video encoder 20 and video decoder 30 may also use a non-uniform version of TEGk to code a palette map, comprising one or more runs of that specify the number of subsequent samples that belong to the same palette index using a non-uniform TEGk in a coded video bitstream. The techniques of this disclosure may improve coding efficiency when coding palette coding information.

According to aspects of this disclosure, video encoder 20 and video decoder 30 may perform any combination of the techniques for palette coding described herein.

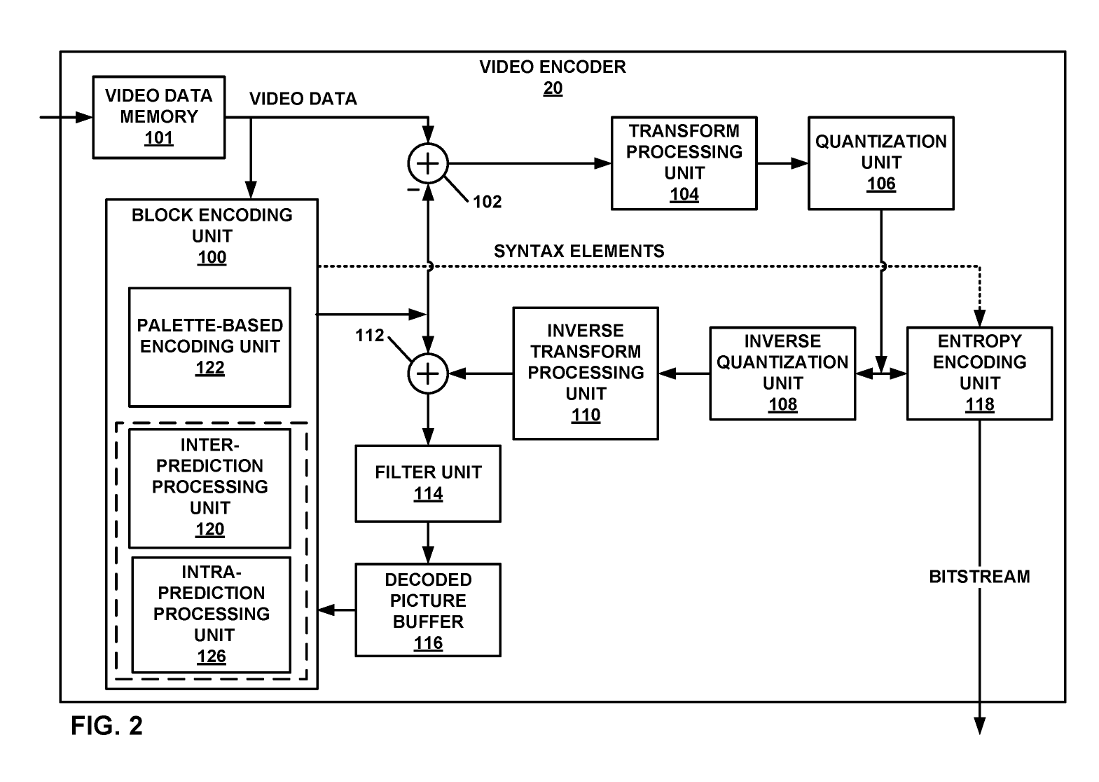

FIG. 2 is a block diagram illustrating an example video encoder 20 that may implement the techniques of this disclosure. FIG. 2 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

Video encoder 20 represents an example of a device that may be configured to perform techniques for palette-based video coding in accordance with various examples described in this disclosure. For example, video encoder 20 may be configured to selectively code various blocks of video data, such as CUs or PUs in HEVC coding, using either palette-based coding or non-palette based coding. Non-palette based coding modes may refer to various inter-predictive temporal coding modes or intra-predictive spatial coding modes, such as the various coding modes specified by HEVC Draft 10. Video encoder 20, in one example, may be configured to generate a palette having entries indicating pixel values, select pixel values in a palette to represent pixels values of at least some pixel locations in a block of video data, and signal information associating at least some of the pixel locations in the block of video data with entries in the palette corresponding, respectively, to the selected pixel values in the palette. The signaled information may be used by video decoder 30 to decode video data.

In the example of FIG. 2, video encoder 20 includes a block encoding unit 100, video data memory 101, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Block encoding unit 100 includes an inter-prediction processing unit 120 and an intra-prediction processing unit 126. Inter-prediction processing unit 120 includes a motion estimation unit and a motion compensation unit (not shown). Video encoder 20 also includes a palette-based encoding unit 122 configured to perform various aspects of the palette-based coding techniques described in this disclosure. In other examples, video encoder 20 may include more, fewer, or different functional components.

Video data memory 101 may store video data to be encoded by the components of video encoder 20. The video data stored in video data memory 101 may be obtained, for example, from video source 18. Decoded picture buffer 116 may be a reference picture memory that stores reference video data for use in encoding video data by video encoder 20, e.g., in intra- or inter-coding modes. Video data memory 101 and decoded picture buffer 116 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 101 and decoded picture buffer 116 may be provided by the same memory device or separate memory devices. In various examples, video data memory 101 may be on-chip with other components of video encoder 20, or off-chip relative to those components.

Video encoder 20 may receive video data. Video encoder 20 may encode each CTU in a slice of a picture of the video data. Each of the CTUs may be associated with equally-sized luma coding tree blocks (CTBs) and corresponding CTBs of the picture. As part of encoding a CTU, block encoding unit 100 may perform quad-tree partitioning to divide the CTBs of the CTU into progressively-smaller blocks. The smaller block may be coding blocks of CUs. For example, block encoding unit 100 may partition a CTB associated with a CTU into four equally-sized sub-blocks, partition one or more of the sub-blocks into four equally-sized sub-sub-blocks, and so on.

Video encoder 20 may encode CUs of a CTU to generate encoded representations of the CUs (i.e., coded CUs). As part of encoding a CU, block encoding unit 100 may partition the coding blocks associated with the CU among one or more PUs of the CU. Thus, each PU may be associated with a luma prediction block and corresponding chroma prediction blocks. Video encoder 20 and video decoder 30 may support PUs having various sizes. As indicated above, the size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Inter-prediction processing unit 120 may generate predictive data for a PU by performing inter prediction on each PU of a CU. The predictive data for the PU may include predictive blocks of the PU and motion information for the PU. Inter-prediction unit 121 may perform different operations for a PU of a CU depending on whether the PU is in an I slice, a P slice, or a B slice. In an I slice, all PUs are intra predicted. Hence, if the PU is in an I slice, inter-prediction unit 121 does not perform inter prediction on the PU. Thus, for blocks encoded in I-mode, the predicted block is formed using spatial prediction from previously-encoded neighboring blocks within the same frame.

If a PU is in a P slice, the motion estimation unit of inter-prediction processing unit 120 may search the reference pictures in a list of reference pictures (e.g., “RefPicList0”) for a reference region for the PU. The reference region for the PU may be a region, within a reference picture, that contains sample blocks that most closely corresponds to the sample blocks of the PU. The motion estimation unit may generate a reference index that indicates a position in RefPicList0 of the reference picture containing the reference region for the PU. In addition, the motion estimation unit may generate an MV that indicates a spatial displacement between a coding block of the PU and a reference location associated with the reference region. For instance, the MV may be a two-dimensional vector that provides an offset from the coordinates in the current decoded picture to coordinates in a reference picture. The motion estimation unit may output the reference index and the MV as the motion information of the PU. The motion compensation unit of inter-prediction processing unit 120 may generate the predictive blocks of the PU based on actual or interpolated samples at the reference location indicated by the motion vector of the PU.

If a PU is in a B slice, the motion estimation unit may perform uni-prediction or bi-prediction for the PU. To perform uni-prediction for the PU, the motion estimation unit may search the reference pictures of RefPicList0 or a second reference picture list (“RefPicList1”) for a reference region for the PU. The motion estimation unit may output, as the motion information of the PU, a reference index that indicates a position in RefPicList0 or RefPicList1 of the reference picture that contains the reference region, an MV that indicates a spatial displacement between a prediction block of the PU and a reference location associated with the reference region, and one or more prediction direction indicators that indicate whether the reference picture is in RefPicList0 or RefPicList1. The motion compensation unit of inter-prediction processing unit 120 may generate the predictive blocks of the PU based at least in part on actual or interpolated samples at the reference region indicated by the motion vector of the PU.

To perform bi-directional inter prediction for a PU, the motion estimation unit may search the reference pictures in RefPicList0 for a reference region for the PU and may also search the reference pictures in RefPicList1 for another reference region for the PU. The motion estimation unit may generate reference picture indexes that indicate positions in RefPicList0 and RefPicList1 of the reference pictures that contain the reference regions. In addition, the motion estimation unit may generate MVs that indicate spatial displacements between the reference location associated with the reference regions and a sample block of the PU. The motion information of the PU may include the reference indexes and the MVs of the PU. The motion compensation unit may generate the predictive blocks of the PU based at least in part on actual or interpolated samples at the reference regions indicated by the motion vectors of the PU.

In accordance with various examples of this disclosure, video encoder 20 may be configured to perform palette-based video coding. With respect to the HEVC framework, as an example, the palette-based video coding techniques may be configured to be used at the CU level. In other examples, the palette-based video coding techniques may be configured to be used at the PU level. In other examples, the palette-based video coding techniques may be configured to be used at the sub-prediction unit (sub-PU) level (e.g., a sub-block of a prediction unit). Accordingly, all of the disclosed processes described herein (throughout this disclosure) in the context of a CU level may, additionally or alternatively, apply to a PU level or a sub-PU level. However, these HEVC-based examples should not be considered a restriction or limitation of the palette-based video coding techniques described herein, as such techniques may be applied to work independently or as part of other existing or yet to be developed systems/standards. In these cases, the unit for palette coding can be square blocks, rectangular blocks or even regions of non-rectangular shape.

Palette-based encoding unit 122, for example, may perform palette-based decoding when a palette-based encoding mode is selected, e.g., for a CU or PU. For example, palette-based encoding unit 122 may be configure to generate a palette having entries indicating pixel values, select pixel values in a palette to represent pixels values of at least some positions of a block of video data, and signal information associating at least some of the positions of the block of video data with entries in the palette corresponding, respectively, to the selected pixel values. Although various functions are described as being performed by palette-based encoding unit 122, some or all of such functions may be performed by other processing units, or a combination of different processing units.

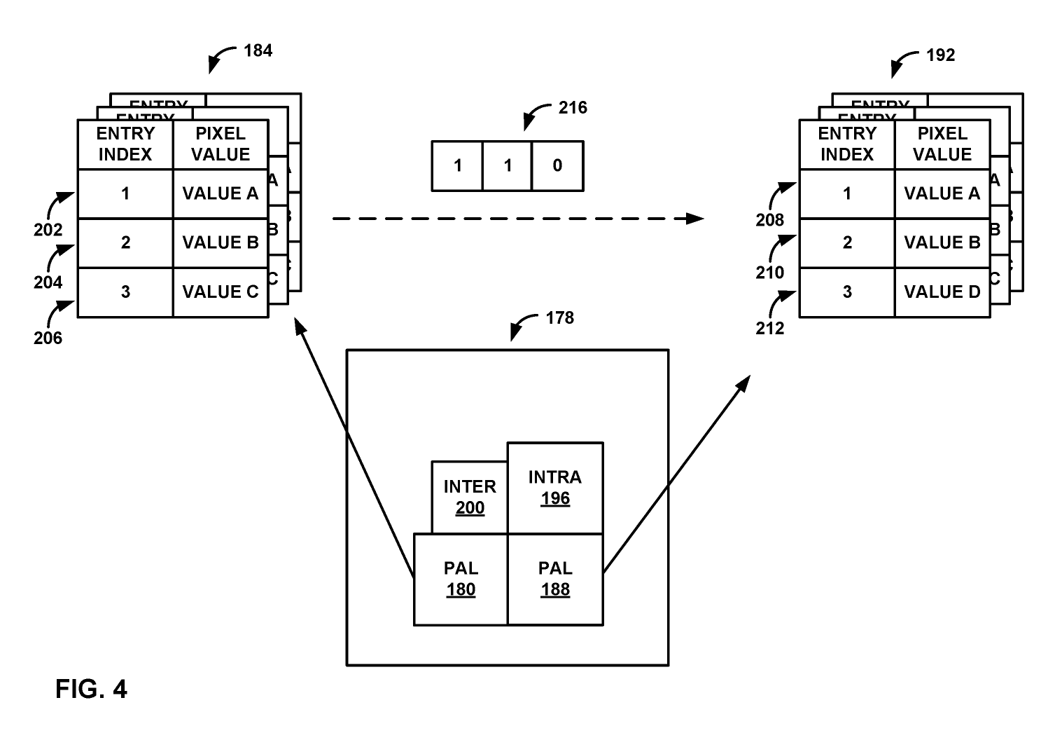

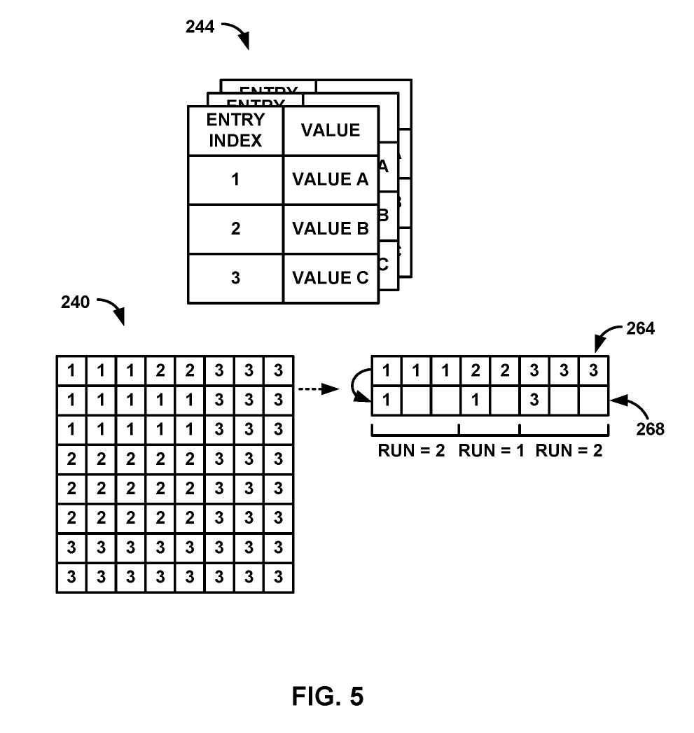

According to aspects of this disclosure, palette-based encoding unit 122 may be configured to perform any combination of the techniques for palette coding described herein, such as with respect to FIGS. 4-5 below.

Intra-prediction processing unit 126 may generate predictive data for a PU by performing intra prediction on the PU. The predictive data for the PU may include predictive blocks for the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. Intra-prediction processing unit 126 may use samples from sample blocks of neighboring PUs to generate a predictive block for a PU. The neighboring PUs may be above, above and to the right, above and to the left, or to the left of the PU, assuming a left-to-right, top-to-bottom encoding order for PUs, CUs, and CTUs. Intra-prediction processing unit 126 may use various numbers of intra prediction modes, e.g., 33 directional intra prediction modes. In some examples, the number of intra prediction modes may depend on the size of the region associated with the PU.

Block encoding unit 100 may select the predictive data for PUs of a CU from among the predictive data generated by inter-prediction processing unit 120 for the PUs or the predictive data generated by intra-prediction processing unit 126 for the PUs. In some examples, block encoding unit 100 selects the predictive data for the PUs of the CU based on rate/distortion metrics of the sets of predictive data. The predictive blocks of the selected predictive data may be referred to herein as the selected predictive blocks.

Residual generation unit 102 may generate, based on the luma, Cb and Cr coding block of a CU and the selected predictive luma, Cb and Cr blocks of the PUs of the CU, a luma, Cb and Cr residual blocks of the CU. For instance, residual generation unit 102 may generate the residual blocks of the CU such that each sample in the residual blocks has a value equal to a difference between a sample in a coding block of the CU and a corresponding sample in a corresponding selected predictive block of a PU of the CU.

Transform processing unit 104 may perform quad-tree partitioning to partition the residual blocks associated with a CU into transform blocks associated with TUs of the CU. Thus, a TU may be associated with a luma transform block and two chroma transform blocks. The sizes and positions of the luma and chroma transform blocks of TUs of a CU may or may not be based on the sizes and positions of prediction blocks of the PUs of the CU. A quad-tree structure known as a “residual quad-tree” (RQT) may include nodes associated with each of the regions. The TUs of a CU may correspond to leaf nodes of the RQT.

Transform processing unit 104 may generate transform coefficient blocks for each TU of a CU by applying one or more transforms to the transform blocks of the TU. Transform processing unit 104 may apply various transforms to a transform block associated with a TU. For example, transform processing unit 104 may apply a discrete cosine transform (DCT), a directional transform, or a conceptually similar transform to a transform block. In some examples, transform processing unit 104 does not apply transforms to a transform block. In such examples, the transform block may be treated as a transform coefficient block.

Quantization unit 106 may quantize the transform coefficients in a coefficient block. The quantization process may reduce the bit depth associated with some or all of the transform coefficients. For example, an n-bit transform coefficient may be rounded down to an m-bit transform coefficient during quantization, where n is greater than m. Quantization unit 106 may quantize a coefficient block associated with a TU of a CU based on a quantization parameter (QP) value associated with the CU. Video encoder 20 may adjust the degree of quantization applied to the coefficient blocks associated with a CU by adjusting the QP value associated with the CU. Quantization may introduce loss of information, thus quantized transform coefficients may have lower precision than the original ones.

Inverse quantization unit 108 and inverse transform processing unit 110 may apply inverse quantization and inverse transforms to a coefficient block, respectively, to reconstruct a residual block from the coefficient block. Reconstruction unit 112 may add the reconstructed residual block to corresponding samples from one or more predictive blocks generated by block encoding unit 100 to produce a reconstructed transform block associated with a TU. By reconstructing transform blocks for each TU of a CU in this way, video encoder 20 may reconstruct the coding blocks of the CU.

Filter unit 114 may perform one or more deblocking operations to reduce blocking artifacts in the coding blocks associated with a CU. Filter unit 114 may perform other filtering operations, including sample adaptive offset (SAO) filtering and/or adaptive loop filtering (ALF). Decoded picture buffer 116 may store the reconstructed coding blocks after filter unit 114 performs the one or more deblocking operations on the reconstructed coding blocks. Inter-prediction processing unit 120 may use a reference picture that contains the reconstructed coding blocks to perform inter prediction on PUs of other pictures. In addition, intra-prediction processing unit 126 may use reconstructed coding blocks in decoded picture buffer 116 to perform intra prediction on other PUs in the same picture as the CU.

Entropy encoding unit 118 may receive data from other functional components of video encoder 20. For example, entropy encoding unit 118 may receive coefficient blocks from quantization unit 106 and may receive syntax elements from block encoding unit 100. Entropy encoding unit 118 may perform one or more entropy encoding operations on the data to generate entropy-encoded data. For example, entropy encoding unit 118 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 118. For instance, the bitstream may include data that represents a RQT for a CU.

Entropy encoding unit 118 may be configured to code palette data using non-uniform TEGk in accordance with the techniques of this disclosure. Entropy encoding unit 118 may be configured to code palette data using k^{th} order Exp-Golomb (EGk) code, k^{th} order truncated Exp-Golomb (TEGk) code, k^{th} order non-uniform truncated Exp-Golomb (TEGk) code, or any combination thereof. As described herein, entropy encoding unit 118 may be configured to compute, calculate, or otherwise implement k^{th} order Exp-Golomb (EGk) code, k^{th} order truncated Exp-Golomb (TEGk) code, k^{th} order non-uniform truncated Exp-Golomb (TEGk) code, or any combination thereof.

For example, entropy encoding unit 118 may be configured to code palette data using k^{th} order Exp-Golomb (EGk) code. A k^{th} order Exp-Golomb (EGk) code word is composed of two parts, a prefix and a suffix. For a given unsigned integer x, the prefix part of the EGk code word comprises (and in some instances consists of) a unary code corresponding to the value of

$$l ( x ) = ⌊ {log}_{2} ( \frac{x}{{2}^{k}} + 1 ) ⌋ .$$

Entropy encoding unit 118 may be configured to compute the suffix as the binary representation of x−2^{k} (2^{l(x)}−1) using k+l(x) bits. As an example, Table I presents some code words for Exponential-Golomb Codes having order 0 (EG0). As used herein, l(x) represents the prefix code word value for a particular value of x.

TABLE I
Example of EG0

| Value x | Code word (prefix-suffix) | Code word length |
|---|---|---|
| 0 | 1 | 1 |
| 1 | 01-0 | 3 |
| 2 | 01-1 | 3 |
| 3 | 001-00 | 5 |
| 4 | 001-01 | 5 |
| 5 | 001-10 | 5 |
| 6 | 001-11 | 5 |

As another example, entropy encoding unit 118 may be configured to code palette data using k^{th} order truncated Exp-Golomb (TEGk) code. In some examples, TEGk code words may be suitable for use in coding run-length values when the maximum possible run-length is known.

Similar to EGk, a k^{th} order truncated Exp-Golomb (TEGk) code word is also composed of two parts, a prefix and a suffix. For a given unsigned integer x and its largest possible value X, the prefix part of the EGk code word comprises (and in some instances consists of) a truncated unary code corresponding to the value of l(x)=

$$⌊ {log}_{2} ( \frac{x}{{2}^{k}} + 1 ) ⌋ .$$

Additionally, entropy encoding unit 118 may avoid or truncate the ‘trailing one’ of the unary code if

$$⌊ {log}_{2} ( \frac{X}{{2}^{k}} + 1 ) ⌋ == l ( x ) .$$

If entropy encoding unit 118 determines that the prefix is truncated, i.e.,

$$⌊ {log}_{2} ( \frac{X}{{2}^{k}} + 1 ) ⌋ == l ( x ) ,$$

entropy encoding unit 118 may compute the suffix part of TEGk as the truncated binary representation of x−2^{k}(2^{l(x)}−1) using k+l(x) or k+l(x)−1 bits. The maximum symbol value for the input of TEGk code is X−2^{k}(2^{l(x)}−1).

If the prefix for TEGk code is not truncated, the suffix part of TEGk is the same as the EGk suffix representation, i.e. the binary representation of x−2^{k}(2^{l(x)}−1) using k+l(x) bits. Table II illustrates example code words for TEG order 0 (TEG0).

TABLE II
Example of TEG0 (X = 5)

| Value x | Code word (prefix-suffix) | Code word length |
|---|---|---|
| 0 | 1 | 1 |
| 1 | 01-0 | 3 |
| 2 | 01-1 | 3 |
| 3 | 00-0 | 3 |
| 4 | 00-10 | 4 |
| 5 | 00-11 | 4 |

Additionally, a video coder may implement the same code according to Table IIA, below:

TABLE IIA
Example of TEG0 (X = 5), alternate implementation to Table II

| Value x | Code word (prefix-suffix) | Code word length |
|---|---|---|
| 0 | 0 | 1 |
| 1 | 10-0 | 3 |
| 2 | 10-1 | 3 |
| 3 | 11-0 | 3 |
| 4 | 11-10 | 4 |
| 5 | 11-11 | 4 |

This disclosure introduces a new variant of EGk, referred to herein as non-uniform TEGk. Entropy encoding unit 118 may be configured to code palette data using k^{th} order non-uniform TEGk code. Similar to EGk and TEGk, non-uniform TEGk code may also be composed of a prefix code and a suffix code. The prefix part of the non-uniform TEGk is truncated unary code, which may be the same as TEGk if the TEGk prefix is truncated. The suffix code for the non-uniform TEGk code may be computed differently from the suffix code for TEGk.

For example, if the prefix code for the non-uniform TEGk code does not correspond to the maximum possible prefix value (e.g., is not truncated), the suffix code of non-uniform TEGk may be the same as EGk and TEGk, i.e. a binary representation of x−2^{k}(2^{l(x)}−1) using k+l(x) bits. In some of the examples below, underlined text may indicate a change relative to a TEGk representation.

However, if the prefix code for non-uniform TEGk code is truncated, i.e.,

$$⌊ {log}_{2} ( \frac{X}{{2}^{k}} + 1 ) ⌋ == l ( x ) ,$$

entropy encoding unit 118 may be configured to compute the suffix code of non-uniform TEGk code (e.g., assuming the suffix code is not an empty string) as:
1) If X==x, i.e., if the symbol is equal to the maximum possible value, the suffix is ‘1’
2) If X>x, i.e., if the symbol is not equal to the maximum possible value, the suffix is calculated as:

‘0’ concatenated by the truncated binary representation of x−2^{k}(2^{l(x)}−1).

The maximum symbol value for the suffix is equal to X−2^{k}(2^{l(x)}−1)−1.

Table III illustrates example code words for non-uniform TEG order 0.

TABLE III
Example of non-uniform TEG0 (X = 5)

| Value x | Code word (prefix-suffix) | Code word length |
|---|---|---|
| 0 | 1 | 1 |
| 1 | 01-0 | 3 |
| 2 | 01-1 | 3 |
| 3 | 00-00 | 4 |
| 4 | 00-01 | 4 |
| 5 | 00-1 | 3 |

Table IV illustrates example code words for non-uniform TEG order 0 according to a different implementation.

TABLE IV
Example of non-uniform TEG0 (X = 5)

| Value x | Code word (prefix-suffix) | Code word length |
|---|---|---|
| 0 | 1 | 1 |
| 1 | 10-0 | 3 |
| 2 | 10-1 | 3 |
| 3 | 11-00 | 4 |
| 4 | 11-01 | 4 |
| 5 | 11-1 | 3 |

In other examples, entropy encoding unit 118 may be configured to compute the suffix code (e.g., if the suffix code is not an empty string) of non-uniform TEGk code as follows:
1) If X==x, i.e., if the symbol equals to the maximum possible value, the suffix is ‘0’
2) If X>x, i.e. if the symbol is not equal to the maximum possible value, the suffix is:

1′ concatenated by the truncated binary representation of x−2^{k}(2^{l(x)}−1).

The maximum symbol value for the suffix is X−2^{k}(2^{l(x)}−1)−1.

In some examples, video encoder 20 may be configured to append or insert a flag to indicate whether the current run reaches the end of the block if the prefix code part of a non-uniform TEGk or TEGk is truncated. If prefix code is truncated, video encoder 20 may be configured to not use any more bits to code the current palette_run syntax element. As described herein, this flag may be referred to as end-run flag and this method may be referred to as end-run flag signaling. Alternatively, as a simplified form, a value of palette_run (e.g., palette_run=4) may be reserved to indicate that the current palette_run has reached the end. Hereafter, this method is named as end-run reserve signaling. While coding, appending, inserting, and/or utilizing a flag may be described herein with respect to video encoder 20 being configured to perform such a function, it is understood that one or more components of video encoder may be configured to perform such a function. As one example, entropy encoding unit 118 may be configured to append or insert an end-run flag. In such an example, entropy encoding unit 118 may output an encoded bitstream including the end-run flag. In some examples, it is understood that block encoding unit 100 or a component thereof (e.g., palette-based encoding unit 122) may instruct entropy encoding unit 118 to insert or append an end-run flag in a bitstream. For example, entropy encoding unit 118 may generate a value for the end-run flag based on an instruction received from block encoding unit 100 or a component thereof, or entropy encoding unit 118 may receive a value for the end-run flag to encode from block encoding unit 100 or a component thereof.

In some examples, video encoder 20 may be configured to utilize the end-run flag to indicate whether X==x. For example, video encoder 20 may be configured to code the end-run flag to indicate whether X==x. As one example, video encoder 20 may be configured to generate and insert the end-run flag between a truncated prefix code word and a suffix code word. In some examples, entropy encoding unit 118 may be configured to generate and insert the end-run flag. In other examples, entropy encoding unit 118 may receive the end-run flag from another component of video encoder 20 (e.g., block encoding unit 100) to which entropy encoding may be applied by entropy encoding unit 118. In another example, video encoder 20 may be configured to insert the end-run flag in the bitstream or otherwise code such a flag, whether or not interleaved between a prefix and a suffix code word. For example, the end-flag may be inserted in a bitstream before a prefix code word, after a suffix code word, or between a prefix code word and a suffix code word. In some examples, entropy encoding unit 118 may be configured to code (or receive) the end-run flag only if a prefix code word is truncated.

The value of the end-run flag may be indicative of the likelihood that the current run goes to the end of the current palette block. For example, if the end-run flag is equal to a value of 1, then the end-run flag may indicate that the current run goes to (or likely goes to) the end of the current palette block. However, if the value of the end-run flag is equal to a value of 0 or if the flag does not exist, then the end-run flag (or absence of the flag) may indicate that the current run does not go to (or is unlikely to go to) the end of the current palette block.

As another example, if the prefix part of a truncated exponential Golomb code is truncated, whether according to non-uniform TEGk or TEGk, then video encoder 20 may be configured to append an end-run flag to indicate whether the current run reaches the end of the block. If so, no more bits are used to code the current palette_run syntax element. Hereafter, this flag is named as end-run flag and this method is named as end-run flag signaling. Alternatively, as a simplified form, a value of palette_run (e.g., palette_run=4) may be reserved to indicate that the current palette_run has reached the end. Hereafter, this method is named as end-run reserve signaling.

As used herein, the term “flag” may comprise one or more bits. Accordingly, an end-run flag may comprise one or more bits. For example, a single bit end-run flag may have one of two values (0 or 1) when signaled. As another example, a two-bit end-run flag may have one four values (00, 01, 10, or 11) when signaled. In some examples, the end-run flag may be referred to as a palette mode syntax element. In other examples, the end-run flag, run-length value, binary palette prediction vector, any palette mode information, and/or any combinations thereof may collectively in any combination or singularly constitute a palette mode syntax element.

Entropy encoding unit 118 may be configured to code palette data using a k^{th} order non-uniform TEGk code word for coding a palette-based syntax element, such as run-length (e.g., run-length value) and/or a binary palette prediction vector.

In some examples, entropy encoding unit 118 may calculate a simplified version of a non-uniform TEGk. In this example, entropy encoding unit 118 may calculate a suffix code of the non-uniform TEGk as follows if the prefix is truncated, and if the suffix code is not an empty string:
1) If X==x, i.e., the symbol equals to the maximum possible value, the suffix is ‘1’
2) If X>x, i.e., the symbol does not equal to the maximum possible value, the suffix is:

‘0’ concatenated by the fixed length code representation of x−2^{k}(2^{l(x)}−1).

The maximum symbol value for the fixed length code is −2^{k}(2^{l(x)}−1)−1.

Alternatively, entropy encoding unit 118 may calculate the suffix code as:
1) If X==x, i.e., the symbol equals to the maximum possible value, the suffix is ‘0’
2) If X>x, i.e., the symbol does not equal the maximum possible value, the suffix is:
   ‘1’ concatenated by the fixed length code representation of x−2^{k}(2^{l(x)}−1),
   and the maximum symbol value for the fixed length code is X−2ₖ(2^{l(x)}−1)−1.

In some examples, to code a syntax element, such as run-length or binary palette prediction vector, for each CU, the first occurrence of a corresponding syntax may be coded by entropy encoding unit 118 using TEGk. Subsequent occurrences of the same syntax element in the same CU may be coded by entropy encoding unit 118 using non-uniform TEGk or the simplified version of non-uniform TEGk described above.

Alternatively, entropy encoding unit 118 may be configured to encode the first occurrence of the corresponding syntax using EGk. Entropy encoding unit 118 may be configured to encode the rest of the same syntax elements in the same CU using a non-uniform TEGk or the simplified version of non-uniform TEGk described above.

In some examples, entropy encoding unit 118 may be configured to use non-uniform TEGk code to code a binary palette prediction vector on top of (i.e. in conjunction with) the binary predictor palette coding techniques described in the document: “Run-length coding for palette predictor,” JCTVC-R0228, available at: http://phenix.int-evey.fr/jct/doc_end_user/current document.php?id=9299. In this example, the maximal run-length value X is equal to (number of palette entries in the palette predictor list−current position in scanning order−1). In some examples, entropy encoding unit 118 may be configured to use a non-uniform TEG0 coding scheme to code a binary palette prediction vector.

In some examples, entropy encoding unit 118 may be configured to use non-uniform TEGk to code the run-length (e.g., run-length value) of a sample index map in palette mode. In this example, the maximal run value X is equal to (number of pixels in the current CU−current position in scanning order−1). Alternatively, if the run-length value is first coded using a truncated unary prefix, entropy encoding unit 118 or another component of video encoder 20 (e.g., palette-based encoding unit 122) may be configured to adjust the maximum run value accordingly. For example, in palette mode coding, entropy encoding unit 118 may be configured to first code the run-length with up to three bins indicating greater than 0, greater than 1, and greater than 2. If the run-length is greater than 2, entropy encoding unit 118 may be configured to use non-uniform TEGk code to code the remaining run-length, with the maximum run value equal to: number of pixels in the current CU−current position in scanning order−4. The configuration for these examples may be a non-uniform TEG2 (i.e. 2^{nd} order non-uniform TEG) in some cases. In some examples, a one bit truncated unary prefix specifies whether the palette_run syntax element is equal to zero or not, followed by a non-uniform TEG0 if the palette_run syntax element is not equal to zero. The palette_run syntax element may indicate a length of a run in the palette, in some examples.

In some examples, entropy encoding unit 118 may code one or more syntax elements, such as a sample index map in palette mode, using a coding mode referred to as “non-uniform EGk.” A non-uniform EGk coding scheme includes a unary-coded prefix code, and an optional unary-coded the suffix code (if necessary). Entropy encoding unit 118 may code the suffix of the non-uniform EGk code as follows:

1) If x<2^{k}(2^{l(x)+1}−1), entropy encoding unit 118 may code a flag to indicate whether X==x, followed by a fixed length code representation of x−2^{k}(2^{l(x)}−1) if X≠x. In this example, x is a given unsigned integer to be coded, and X is a maximum possible value that can be coded.
2) If X>x, i.e., the symbol is not equal to the maximum possible value that can be coded, entropy encoding unit 118 may encode a fixed length code representation of x−2^{k}(2^{l(x)}−1) into a coded video bitstream.

In some example, entropy encoding unit 118 may code the prefix as a unary code and an optional suffix code. After coding the prefix unary code, entropy encoding unit 118 may code the optional suffix code (if necessary) as follows:
1) entropy encoding unit 118 may code a flag to indicate whether X==x,
2) followed by a fixed length code representation of x−2^{k}(2^{l(x)}−1), if X≠x.

Video encoder 20 and video decoder 30 may perform the techniques described in this disclosure in any combination. For example, entropy encoding unit 118 and entropy decoding unit 150 may combine: coding a first occurrence of a syntax element using TEGk and subsequent syntax elements using non-uniform TEGk, coding a binary palette prediction vector using non-uniform TEGk, coding a run-length of a sample index map in palette mode using non-uniform TEGk, and/or coding a copy-above run-length using TEGk, with one or more of: the non-uniform EGk coding, simplified unary-coded prefix and unary-coded suffix coding, and/or simplified TEGk coding techniques described above.

In some examples, entropy encoding unit 118 may use any exponential Golomb code family, such as EGk, TEGk, non-Uniform TEGk and/or simplified forms of these code families to code palette-related syntax elements, such as the palette-related syntax elements mentioned above (or elsewhere in this disclosure). In some examples, entropy encoding unit 118 may code a predetermined codeword to represent that a current run (e.g., of a palette) has reached the end of a current block of a CU. For example, entropy encoding unit 118 can signal a fixed codeword, such as a palette_run codeword, where the value of palette_run is equal to L (e.g., a longest possible run) to indicate that the current run reaches the end of the current block.

Similarly, if entropy decoding unit 150 decodes the palette_run syntax element, and palette_run is equal to L, entropy decoding unit 150 infers that the current run of the palette is the last run of the block. Correspondingly, if the decoded run value of palette_run is larger than L, entropy decoding unit 150 may adjust the actual run of the palette_run syntax element to be equal to (L−1). Otherwise, (i.e., if the decoded run value palette_run is smaller than L), entropy decoding unit 150 may determine that the actual run value is equal to palette_run.

As another example, to code the palette_run syntax element, entropy encoding unit 118 may encode the prefix code of the exponential code family out of the range of the current block. For example, after entropy decoding unit 150 decodes the prefix code l(x), the value of the palette_run syntax element may be in the range of 2^{k}(2^{l(x)}−1)≦x<2^{k}(2^{l(x)+1}−1). Therefore, when the current palette_run reaches the end of the current block, entropy encoding unit 118 may code the prefix l(x) such that 2^{k}(2^{l(x)}−1)≧X. In this way, after entropy decoding unit 150 decodes the prefix, the video decoder 30 may determine that the current run, indicated by the palette_run syntax element, has reached its end. Therefore, no further decoding of the palette_run syntax element or other palette-related syntax elements may be necessary, and entropy encoding unit 118 and entropy decoding unit 150 may bypass coding the suffix value.

In another example, video encoder 20 may code a CU-level flag syntax element, referred to as palette_transpose_flag. The flag may indicate whether a palette block (e.g., a block of video data represented by palette index values) should be traversed using a horizontal snake-like scan order or a vertical snake-like scan order. When using the snake-like scan order, also referred to as a “serpentine traverse,” video encoder 20 or video decoder 30 may traverse the palette in alternating left-to-right and right-to-left order, alternating on a line-by-line basis for a block of the CU or for all blocks of the CU. When using the vertical snake-like scan order, video encoder 20 or video decoder 30 may traverse the palette block (e.g., the block of video data represented by palette index values) in alternating top-to-bottom, bottom-to-top order, alternating on a line-by-line basis.

In some examples, video encoder 20 may code another CU-level flag, referred to as palette_flip_flag. The value of palette_flip_flag may indicate whether the scan order is flipped (i.e., reversed) or not. For example, if palette_flip_flag is enabled, before or after scanning, video encoder 20 or video decoder 30 may flip (e.g., reverse) the samples in the palette block according to the following equation: Sample[cIdx] [x][y]=Sample[cIdx][nCbS−x−1][nCbS−y−1], where nCbS is the size of the current coding block, and cIdx is an index value that indicates whether the palette block is a luma block, or a chroma block.

In one example of the disclosure, entropy encoding unit 118 may be configured to generate a flag, syntax element, or other indicator (or other syntax information) to indicate a selected method for palette run coding. That is the flag, syntax element or other indicator may indicate a particular palette run coding technique among two or more possible palette run coding techniques. For example, a flag, syntax element or other indicator may specify whether the current HEVC palette run coding technique is used, or if the proposed run-to-the-end technique proposed in this disclosure is used. The flag, syntax element or other indicator may be signaled in at least one of a] video parameter set (VPS), picture parameter set (PPS), sequence parameter set (SPS), slice header, at coding unit (CU) level, at a coding tree unit (CTU) level, or elsewhere.

In another example of the disclosure, video encoder 20 may be configured to conditionally signal the end-run flag based on the value of the palette_mode syntax element (i.e., COPY_ABOVE, INDEX, or ESCAPE). If the value of the palette_mode syntax element indicates INDEX mode, end-run flag signaling may also depend on the parsed or decoded value of the palette_index syntax element. If the value of the palette_mode syntax element indicates COPY_ABOVE above, the end-run flag signaling may also depend on the parsed or decoded value of the palette_index syntax element of its above neighbor.

In another example of the disclosure, instead of conditionally signaling the end-run flag, the end-run flag may be coded with CABAC using different contexts. The contexts may depend on the value of the palette_mode syntax element (i.e., COPY_ABOVE, INDEX, or ESCAPE). If the value of the palette_mode syntax element indicates INDEX mode, the contexts used for the end-run flag may also depend on the parsed or decoded value of the palette_index syntax element. If the value of the palette_mode indicates COPY_ABOVE mode, the contexts used for the end-run flag may also depend on the parsed or decoded value of the palette_index syntax elements of its above neighbor.

In another example of the disclosure, video encoder 20 may be configured to signal end-run flag only when the value of the palette_mode syntax elements indicates COPY_ABOVE mode or only when the value of the palette_mode syntax element indicates INDEX mode. When the use of the end-run flag is enabled, the conditional signaling or splitting contexts approaches stated above may be applied. Since escape coded pixels can be used with block coded with INDEX or COPY_ABOVE mode, in addition to the above-described context derivation techniques, the ESCAPE pixel mode can be taken into account for further context refining. For example, the palette index value may be used to determine a context if ESCAPE mode is not used.

In another example of the disclosure, the end-run flag may be conditionally signaled depending on the palette size, CU size, value of the palette_share_flag, or the value of the palette_transpose_flag. Alternatively, instead of conditionally signaling the end-run flag, the end-run flag can be coded with CABAC using different contexts. The contexts may depend on the palette size, CU size, value of the palette_share_flag, or the value of the palette_transpose_flag.

In another example of the disclosure, the end-run flag can be conditionally signaled depending on the starting position of the run being coded/decoded in the CU, or after certain occurrences of the palette run syntax element in the block. In one example, the end-run flag is not signaled for the first occurrence of palette_run syntax element in the current block.

Alternatively, instead of conditionally signaling the end-run flag, the end-run flag can be coded with CABAC using different contexts. The contexts may depend on the starting position of the run being coded/decoded in the CU.

In another example of the disclosure, when the value of the palette_share_flag=0, i.e., the palette is not derived in share mode, the number of occurrences for the palette_run syntax element when the value of the palette_mode indicates the INDEX mode is equal to or greater than palette size. This technique is based on the assumption that video encoder 20 does not generate useless or unused palette entries. The end-run flag may be conditionally signaled only when the number of coded/decoded palette_run syntax elements, including the current palette_run syntax element, is equal to or greater than the size of the palette.

Alternatively, instead of conditionally signaling the end-run flag, the end-run flag can be coded with CABAC using different contexts. The contexts selected for coding the end-run flag may depend on whether or not the number of coded/decoded palette_run syntax elements, including the current one, is equal to or greater than the size of the palette, or may depend on the number of coded/decoded palette_run syntax elements, including the current one.

In another example of the disclosure, when the value of the palette_share_flag syntax element equals 0, i.e., palette is not derived in share mode, the value of the palette_mode indicating the INDEX mode must occur at least once for each valid palette index, based on the assumption that the encoder does not generate useless palette entries. The end-run flag may be conditionally signaled only when the value of the palette_mode syntax element indicates the INDEX mode has occurred at least once for each valid palette index.

Alternatively, instead of conditionally signaling the end-run flag, the end-run flag may be coded with CABAC using different contexts. The contexts may depend on whether the value of the palette_mode syntax element indicating the INDEX mode has occurred at least once for each valid palette index.

In another example of the disclosure, when coding the first occurrence of palette_run syntax element in the current block, the input parameter of the maximum possible palette_run is proposed to be the number of pixels in the block minus 2 instead of the number of pixels in the block minus 1, as in JCTVC-R1005. Using the aforementioned input parameter provides better coding efficiency when combined with techniques where uni-color blocks bypass the coding process of the palette_run syntax element.

In another example of the disclosure, if escape coded pixels can be present in the block and the palette size is possibly greater than zero, for example, as indicated by the value of the palette_escape_val_present_flag, the end-run (run to the end) method may be used after the first or, in general, after a certain number of escape coded pixels in the block. Additionally, the end-run (run to the end) method may be used after the first occurrence of the escape coded pixels included into the same palette mode, i.e., INDEX mode, since several escape pixels can be included into the INDEX or COPY_ABOVE mode. The aforementioned technique may be used assuming that video encoder 20 is not setting the escape present flag if there are no escape coded pixels in the block. In this case, the run value cannot continue to the end of the block unless at least one escape pixel has been already coded, since at least one escape coded pixel has to be coded as indicated by the value palette_escape_val_present_flag and the run will break before that escape pixel.

Alternatively, the context coding can be used in the end-run method, where the context derivation is dependent on the number of previously-coded escape pixels in the block, or the first occurrence of the group of the escape coded pixels.

As a general remark, bitstream conformance constraints can be added mandating the encoder behavior. In some examples, a bitstream conformance condition may be added mandating that every palette index or palette entry included into the palette table has to be used at least once in the block, if palette sharing mode is not used.

Similarly, a bitstream conformance condition may be added mandating that at least one escape coded pixel has to be present in the block, if the block level escape present flag indicates the escape pixels usage, i.e., palette_escape_val_present_flag is equal to 1. If the constraint rules are violated, such a bitstream is treated to be non-conformant to the standard.

The signaling conditions listed above can be applied individually or applied using a subset of them as a combination. Although the above method descriptions use end-run flag signaling, the same condition/principle also applies to end-run reservation signaling.

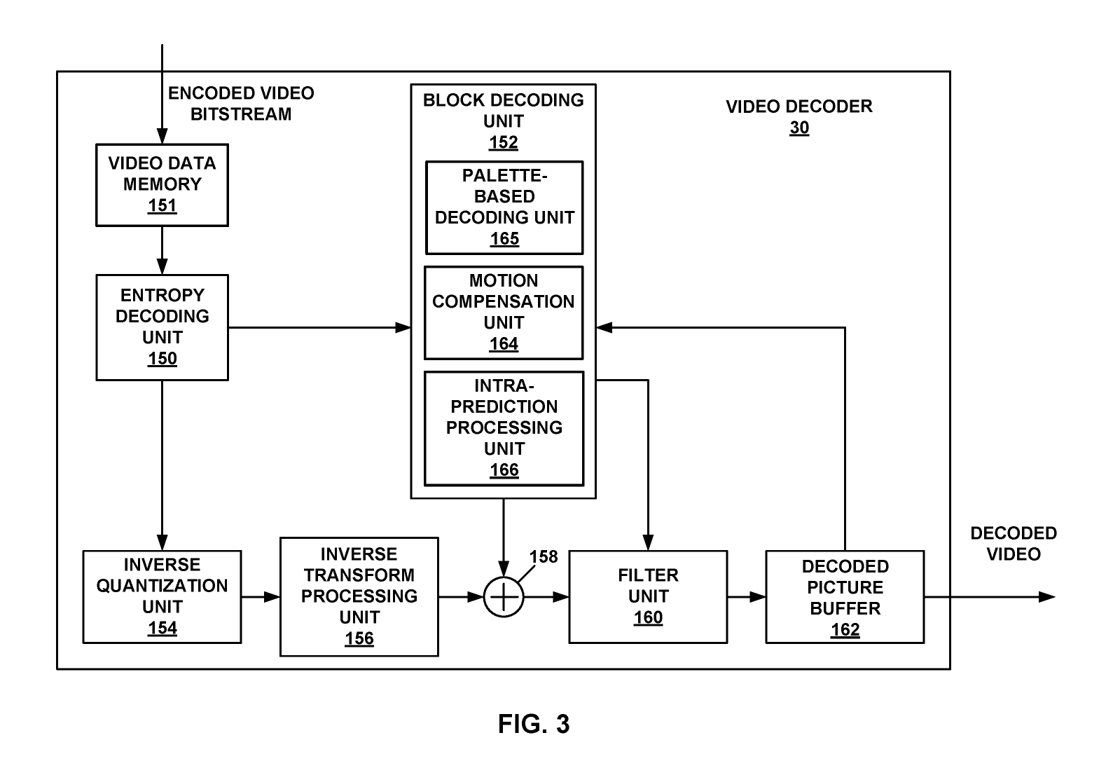

FIG. 3 is a block diagram illustrating an example video decoder 30 that is configured to implement the techniques of this disclosure. FIG. 3 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

The details of palette coding described above with respect to encoder 20 are not repeated here with respect to decoder 30, but it is understood that decoder 30 may perform the reciprocal palette-based decoding process relative to any palette-based encoding process described herein with respect to encoder 20.

Video decoder 30 represents an example of a device that may be configured to perform techniques for palette-based video coding in accordance with various examples described in this disclosure. For example, video decoder 30 may be configured to selectively decode various blocks of video data, such as CUs or PUs in HEVC coding, using either palette-based coding or non-palette based coding. Non-palette based coding modes may refer to various inter-predictive temporal coding modes or intra-predictive spatial coding modes, such as the various coding modes specified by HEVC Draft 10. Video decoder 30, in one example, may be configured to generate a palette having entries indicating pixel values, receive information associating at least some pixel locations in a block of video data with entries in the palette, select pixel values in the palette based on the information, and reconstruct pixel values of the block based on the selected pixel values in the palette.

In the example of FIG. 3, video decoder 30 includes an entropy decoding unit 150, video data memory 151, a block decoding unit 152, an inverse quantization unit 154, an inverse transform processing unit 156, a reconstruction unit 158, a filter unit 160, and a decoded picture buffer 162. Block decoding unit 152 includes a motion compensation unit 164 and an intra-prediction processing unit 166. Video decoder 30 also includes a palette-based decoding unit 165 configured to perform various aspects of the palette-based coding techniques described in this disclosure. In other examples, video decoder 30 may include more, fewer, or different functional components.

Video data memory 151 may store video data, such as an encoded video bitstream, to be decoded by the components of video decoder 30. The video data stored in video data memory 151 may be obtained, for example, from channel 16, e.g., from a local video source, such as a camera, via wired or wireless network communication of video data, or by accessing physical data storage media. Video data memory 151 may form a coded picture buffer (CPB) that stores encoded video data from an encoded video bitstream. Decoded picture buffer 162 may be a reference picture memory that stores reference video data for use in decoding video data by video decoder 30, e.g., in intra- or inter-coding modes. Video data memory 151 and decoded picture buffer 162 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 151 and decoded picture buffer 162 may be provided by the same memory device or separate memory devices. In various examples, video data memory 151 may be on-chip with other components of video decoder 30, or off-chip relative to those components.

A coded picture buffer (CPB) may receive and store encoded video data (e.g., NAL units) of a bitstream. Entropy decoding unit 150 may receive encoded video data (e.g., NAL units) from the CPB and parse the NAL units to decode syntax elements. Entropy decoding unit 150 may entropy decode entropy-encoded syntax elements in the NAL units. Block decoding unit 152, inverse quantization unit 154, inverse transform processing unit 156, reconstruction unit 158, and filter unit 160 may generate decoded video data based on the syntax elements extracted from the bitstream.

Video decoder 30 may be configured to perform a process generally reciprocal to that of video encoder 20 described herein. For example, entropy decoding unit 150 may be configured to perform a process generally reciprocal to that of entropy encoding unit 118 described herein. According to aspects of this disclosure, entropy decoding unit 150 may be configured to entropy decode any code words generated by entropy encoding unit 118. For example, entropy decoding unit 150 may be configured to entropy decode uniform and non-uniform TEGk-encoded values, such as a binary palette prediction vector and/or a palette map for a CU. As another example, entropy decoding unit 150 may be configured to entropy decode a k^{th} order Exp-Golomb (EGk) code word, a k^{th} order truncated Exp-Golomb (TEGk) code word, a k^{th} order non-uniform truncated Exp-Golomb (TEGk) code word, or any combination thereof.

The NAL units of the bitstream may include coded slice NAL units. As part of decoding the bitstream, entropy decoding unit 150 may extract and entropy decode syntax elements from the coded slice NAL units. Each of the coded slices may include a slice header and slice data. The slice header may contain syntax elements pertaining to a slice. The syntax elements in the slice header may include a syntax element that identifies a PPS associated with a picture that contains the slice.

In addition to decoding syntax elements from the bitstream, video decoder 30 may perform a reconstruction operation on a non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct residual blocks of the CU.

As part of performing a reconstruction operation on a TU of a CU, inverse quantization unit 154 may inverse quantize, i.e., de-quantize, coefficient blocks associated with the TU. Inverse quantization unit 154 may use a QP value associated with the CU of the TU to determine a degree of quantization and, likewise, a degree of inverse quantization for inverse quantization unit 154 to apply. That is, the compression ratio, i.e., the ratio of the number of bits used to represent original sequence and the compressed one, may be controlled by adjusting the value of the QP used when quantizing transform coefficients. The compression ratio may also depend on the method of entropy coding employed.

After inverse quantization unit 154 inverse quantizes a coefficient block, inverse transform processing unit 156 may apply one or more inverse transforms to the coefficient block in order to generate a residual block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If a PU is encoded using intra prediction, intra-prediction processing unit 166 may perform intra prediction to generate predictive blocks for the PU. Intra-prediction processing unit 166 may use an intra prediction mode to generate the predictive luma, Cb and Cr blocks for the PU based on the prediction blocks of spatially-neighboring PUs. Intra-prediction processing unit 166 may determine the intra prediction mode for the PU based on one or more syntax elements decoded from the bitstream.

Block decoding unit 152 may construct a first reference picture list (RefPicList0) and a second reference picture list (RefPicList1) based on syntax elements extracted from the bitstream. Furthermore, if a PU is encoded using inter prediction, entropy decoding unit 150 may extract motion information for the PU. Motion compensation unit 164 may determine, based on the motion information of the PU, one or more reference regions for the PU. Motion compensation unit 164 may generate, based on samples blocks at the one or more reference blocks for the PU, predictive luma, Cb and Cr blocks for the PU.

Reconstruction unit 158 may use the luma, Cb and Cr transform blocks associated with TUs of a CU and the predictive luma, Cb and Cr blocks of the PUs of the CU, i.e., either intra-prediction data or inter-prediction data, as applicable, to reconstruct the luma, Cb and Cr coding blocks of the CU. For example, reconstruction unit 158 may add samples of the luma, Cb and Cr transform blocks to corresponding samples of the predictive luma, Cb and Cr blocks to reconstruct the luma, Cb and Cr coding blocks of the CU.

Filter unit 160 may perform a deblocking operation to reduce blocking artifacts associated with the luma, Cb and Cr coding blocks of the CU. Video decoder 30 may store the luma, Cb and Cr coding blocks of the CU in decoded picture buffer 162. Decoded picture buffer 162 may provide reference pictures for subsequent motion compensation, intra prediction, and presentation on a display device, such as display device 32 of FIG. 1. For instance, video decoder 30 may perform, based on the luma, Cb, and Cr blocks in decoded picture buffer 162, intra prediction or inter prediction operations on PUs of other CUs.

In accordance with various examples of this disclosure, video decoder 30 may be configured to perform palette-based coding. Palette-based decoding unit 165, for example, may perform palette-based decoding when a palette-based decoding mode is selected, e.g., for a CU or PU. For example, palette-based decoding unit 165 may be configured to generate a palette having entries indicating pixel values, receive information associating at least some pixel locations in a block of video data with entries in the palette, select pixel values in the palette based on the information, and reconstruct pixel values of the block based on the selected pixel values in the palette. Although various functions are described as being performed by palette-based decoding unit 165, some or all of such functions may be performed by other processing units, or a combination of different processing units.

Palette-based decoding unit 165 may receive palette coding mode information, and perform the above operations when the palette coding mode information indicates that the palette coding mode applies to the block. When the palette coding mode information indicates that the palette coding mode does not apply to the block, or when other mode information indicates the use of a different mode, palette-based decoding unit 165 decodes the block of video data using a non-palette based coding mode, e.g., such an HEVC inter-predictive or intra-predictive coding mode. The block of video data may be, for example, a CU or PU generated according to an HEVC coding process. The palette-based coding mode may comprise one of a plurality of different palette-based coding modes, or there may be a single palette-based coding mode.

According to aspects of this disclosure, palette-based decoding unit 165 may be configured to perform any combination of the techniques for palette coding described herein. The details of palette coding described above with respect to encoder 20 are not repeated here with respect to decoder 30, but it is understood that decoder 30 may perform the reciprocal palette-based decoding process relative to any palette-based encoding process described herein with respect to encoder 20.

FIG. 4 is a conceptual diagram illustrating an example of determining a palette for coding video data, consistent with techniques of this disclosure. The example of FIG. 4 includes a picture 178 having a first PAL (palette) coding unit (CU) 180 that is associated with first palettes 184 and a second PAL CU 188 that is associated with second palettes 192. As described in greater detail below and in accordance with the techniques of this disclosure, second palettes 192 are based on first palettes 184. Picture 178 also includes block 196 coded with an intra-prediction coding mode and block 200 that is coded with an inter-prediction coding mode.

The techniques of FIG. 4 are described in the context of video encoder 20 (FIG. 1 and FIG. 2) and video decoder 30 (FIG. 1 and FIG. 3) and with respect to the HEVC video coding standard for purposes of explanation. However, it should be understood that the techniques of this disclosure are not limited in this way, and may be applied by other video coding processors and/or devices in other video coding processes and/or standards.

In general, a palette refers to a number of pixel values that are dominant and/or representative for a CU currently being coded, CU 188 in the example of FIG. 4. First palettes 184 and second palettes 192 are shown as including multiple palettes. In some examples, according to aspects of this disclosure, a video coder (such as video encoder 20 or video decoder 30) may code palettes separately for each color component of a CU. For example, video encoder 20 may encode a palette for a luma (Y) component of a CU, another palette for a chroma (U) component of the CU, and yet another palette for the chroma (V) component of the CU. In this example, entries of the Y palette may represent Y values of pixels of the CU, entries of the U palette may represent U values of pixels of the CU, and entries of the V palette may represent V values of pixels of the CU.

In other examples, video encoder 20 may encode a single palette for all color components of a CU. In this example, video encoder 20 may encode a palette having an i-th entry that is a triple value, including Yi, Ui, and Vi. In this case, the palette includes values for each of the components of the pixels. Accordingly, the representation of palettes 184 and 192 as a set of palettes having multiple individual palettes is merely one example and not intended to be limiting.

In the example of FIG. 4, first palettes 184 includes three entries 202-206 having entry index value 1, entry index value 2, and entry index value 3, respectively. Entries 202-206 relate the index values to pixel values including pixel value A, pixel value B, and pixel value C, respectively. As described herein, rather than coding the actual pixel values of first CU 180, a video coder (such as video encoder 20 or video decoder 30) may use palette-based coding to code the pixels of the block using the indices 1-3. That is, for each pixel position of first CU 180, video encoder 20 may encode an index value for the pixel, where the index value is associated with a pixel value in one or more of first palettes 184. Video decoder 30 may obtain the index values from a bitstream and reconstruct the pixel values using the index values and one or more of first palettes 184. Thus, first palettes 184 are transmitted by video encoder 20 in an encoded video data bitstream for use by video decoder 30 in palette-based decoding.

In some examples, video encoder 20 and video decoder 30 may determine second palettes 192 based on first palettes 184. For example, video encoder 20 and/or video decoder 30 may locate one or more blocks from which the predictive palettes, in this example, first palettes 184, are determined. In some examples, such as the example illustrated in FIG. 4, video encoder 20 and/or video decoder 30 may locate the previously coded CU such as a left neighboring CU (first CU 180) when determining a predictive palette for second CU 188.

In the example of FIG. 4, second palettes 192 include three entries 208-212 having entry index value 1, entry index value 2, and entry index value 3, respectively. Entries 208-212 relate the index values to pixel values including pixel value A, pixel value B, and pixel value D, respectively. In this example, video encoder 20 may code one or more syntax elements indicating which entries of first palettes 184 are included in second palettes 192. In the example of FIG. 4, the one or more syntax elements are illustrated as a vector 216. Vector 216 has a number of associated bins (or bits), with each bin indicating whether the palette predictor associated with that bin is used to predict an entry of the current palette. For example, vector 216 indicates that the first two entries of first palettes 184 (202 and 204) are included in second palettes 192 (a value of “1” in vector 216), while the third entry of first palettes 184 is not included in second palettes 192 (a value of “0” in vector 216). In the example of FIG. 4, the vector is a Boolean vector.

In some examples, video encoder 20 and video decoder 30 may determine a palette predictor list (which may also be referred to as a palette predictor table) when performing palette prediction. The palette predictor list may include entries from palettes of one or more neighboring blocks that are used to predict one or more entries of a palette for coding a current block. Video encoder 20 and video decoder 30 may construct the list in the same manner. Video encoder 20 and video decoder 30 may code data (such as vector 216) to indicate which entries of the palette predictor list are to be included in a palette for coding a current block.

FIG. 5 is a conceptual diagram illustrating an example of determining indices to a palette for a block of pixels, consistent with techniques of this disclosure. For example, FIG. 5 includes a map 240 of index values (values 1, 2, and 3) that relate respective positions of pixels associated with the index values to an entry of palettes 244.

While map 240 is illustrated in the example of FIG. 5 as including an index value for each pixel position, it should be understood that in other examples, not all pixel positions may be associated with an index value relating the pixel value to an entry of palettes 244. That is, as noted above, in some examples, video encoder 20 may encode (and video decoder 30 may obtain, from an encoded bitstream) an indication of an actual pixel value (or its quantized version) for a position in map 240 if the pixel value is not included in palettes 244.

In some examples, video encoder 20 and video decoder 30 may be configured to code an additional map indicating which pixel positions are associated with index values. For example, assume that the (i, j) entry in the map corresponds to the (i, j) position of a CU. Video encoder 20 may encode one or more syntax elements for each entry of the map (i.e., each pixel position) indicating whether the entry has an associated index value. For example, video encoder 20 may encode a flag having a value of one to indicate that the pixel value at the (i, j) location in the CU is one of the values in palettes 244.

Video encoder 20 may, in such an example, also encode a palette index (shown in the example of FIG. 5 as values 1-3) to indicate that pixel value in the palette and to allow video decoder to reconstruct the pixel value. In instances in which palettes 244 include a single entry and associated pixel value, video encoder 20 may skip the signaling of the index value. Video encoder 20 may encode the flag to have a value of zero to indicate that the pixel value at the (i, j) location in the CU is not one of the values in palettes 244. In this example, video encoder 20 may also encode an indication of the pixel value for use by video decoder 30 in reconstructing the pixel value. In some instances, the pixel value may be coded in a lossy manner.

The value of a pixel in one position of a CU may provide an indication of values of one or more other pixels in other positions of the CU. For example, there may be a relatively high probability that neighboring pixel positions of a CU will have the same pixel value or may be mapped to the same index value (in the case of lossy coding, in which more than one pixel value may be mapped to a single index value).

Accordingly, video encoder 20 may encode one or more syntax elements indicating a number of consecutive pixels or index values in a given scan order that have the same pixel value or index value. As noted above, the string of like-valued pixel or index values may be referred to herein as a run. In an example for purposes of illustration, if two consecutive pixels or indices in a given scan order have different values, the run is equal to zero. If two consecutive pixels or indices in a given scan order have the same value but the third pixel or index in the scan order has a different value, the run is equal to one. For three consecutive indices or pixels with the same value, the run is two, and so forth. Video decoder 30 may obtain the syntax elements indicating a run from an encoded bitstream and use the data to determine the number of consecutive locations that have the same pixel or index value.

As noted above, runs may be used in conjunction with a CopyFromTop or Value mode (also called, copy above mode and index mode, respectively). In an example for purposes of illustration, consider rows 264 and 268 of map 240. Assuming a horizontal, left to right scan direction, row 264 includes three index values of “1,” two index values of “2,” and three index values of “3.” Row 268 includes five index values of “1” and three index values of “3.” In this example, video encoder 20 may identify particular entries of row 264 followed by a run when encoding data for row 268 (e.g., CopyFromTop mode). For example, video encoder 20 may encode one or more syntax elements indicating that the first position of row 268 (the left most position of row 268) is the same as the first position of row 264. Video encoder 20 may also encode one or more syntax elements indicating that the next run of two consecutive entries in the scan direction in row 268 are the same as the corresponding above positions of row 264.

After encoding the one or more syntax elements indicating the first position of row 264 and the run of two entries (noted above), video encoder 20 may encode, for the fourth and fifth positions in line 268 (from left to right), one or more syntax elements indicating a value of 1 for the fourth position and one or more syntax elements indicating a run of 1 (e.g., Value mode). Hence, video encoder 20 encodes these two positions without reference to another line.

Video encoder 20 may then encode the first position having an index value of 3 in row 268 relative to upper row 264 (e.g., indicating a copy from upper row 264 and the run of consecutive positions in the scan order having the same index value). Accordingly, video encoder 20 may select between coding pixel or index values of a line relative to other values of the line, e.g., using a run, coding pixel or index values of a line relative to values of another line (or column), or a combination thereof. Video encoder 20 may, in some examples, perform a rate/distortion optimization to make the selection.

Video decoder 30 may receive the syntax elements described above and reconstruct row 268. For example, video decoder 30 may obtain data indicating a particular location in a neighboring row from which to copy the associated index value for the position of map 240 currently being coded. Video decoder 30 may also obtain data indicating the number of consecutive positions in the scan order having the same index value. While described with respect to a horizontal scan order, the techniques of this disclosure may also be applied to another scan direction, such as a vertical or diagonal (e.g., 45 degrees or 135 degrees diagonally in block) scan direction.

In some examples in accordance with the techniques of this disclosure, entropy encoding unit 118 and entropy decoding unit 150 may use non-uniform TEGk to respectively encode and decode a palette-based syntax element, such as run-length (e.g., run-length value) and/or a binary palette prediction vector. For example, entropy encoding unit 118 and entropy decoding unit 150 may use non-uniform TEGk to respectively encode and decode run-length codes of an index map in palette mode. The maximal run value X for the runs of the index map may be equal to (the number of pixels in the current CU−the current position in scanning order−1).

In examples when the run-length value is first coded using a truncated unary prefix, entropy encoding unit 118 and entropy decoding unit 150 may adjust the maximum run value accordingly. For example, in a current implementation of palette mode coding, a video coder may code run-length first with up to three bins indicating whether the run-length is greater than 0, greater than 1, and greater than 2. If the run-length is greater than 2, the techniques of this disclosure, entropy encoding unit 118 and entropy decoding unit 150 may utilize non-uniform TEGk to code the remaining run-length, with the maximum run value (X) equal to (number of pixels in the current CU−current position in scanning order−4). In these examples of coding the index map, the preferred TEG order is 2 (TEG2).

In some current palette coding video proposals, runs of copy-above (where a video coder copies an index of a pixel above the current pixel) cannot include any escape pixels. That is, a video coder must stop a copy-above run if the current pixel's top-neighboring pixel is an escape pixel. Thus, the maximum copy-above run-length is bounded by the distance between the current pixel position and the position having an above-neighboring pixel that is an escape pixel in the scanning order.

In some examples, assume that the starting position of a copy above run in scanning order is A, and the pixel in position A+L (L>1)'s above-neighboring pixel is an escape pixel, while the pixel at position A+l (l<L)'s above-neighboring pixel is not an escape pixel. If such a pixel L does not exist, video encoder 20 may assign L to the position after the last pixel in the block in scanning order. In accordance with the techniques of this disclosure, video encoder 20 and video decoder 30 may use non-uniform TEGk to code the copy-above run-length with the restriction that the maximum run-length is no longer than L−1. Alternatively, if unary prefixes of greater than 0, greater than 1, and greater than 2 are used when coding run-length, entropy encoding unit 118 or entropy decoding unit 150 may set the maximum run-length of the run of the index map to be coded using non-uniform TEGk may be L−4. As another example, if a unary prefix of greater than 0 is used, the maximum run-length of the non-uniform TEGk may be equal to L−2, if applicable.

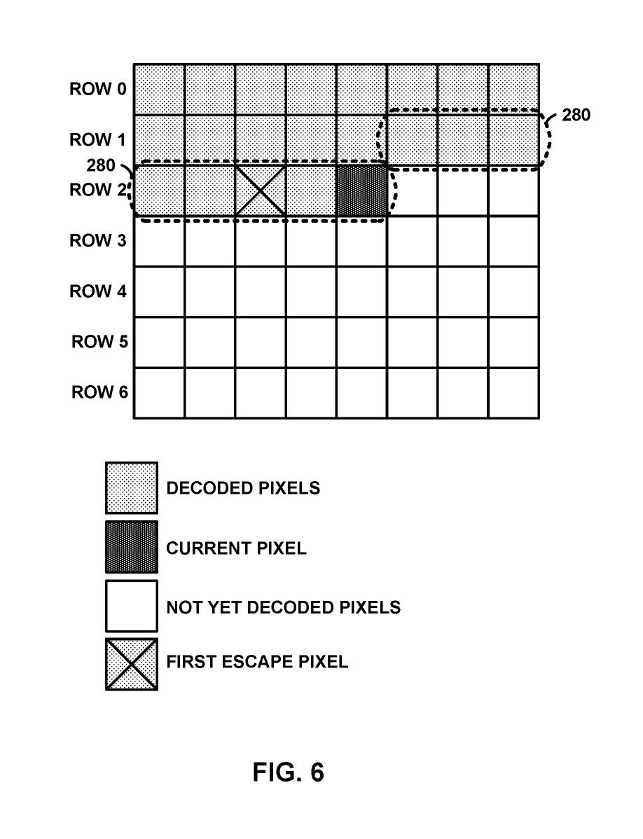

FIG. 6 is a conceptual diagram illustrating an example of determining maximum copy above run-length, assuming an example of a raster scanning order, consistent with techniques of this disclosure. In the example of FIG. 6, if none of the pixels encompassed by dashed lines 280 is coded as an escape sample, the maximum possible run-length is 35 (i.e. the number of unshaded pixel positions). If one or more of the pixels within dashed lines 280 is coded as an escape sample, assuming that the pixel marked as the escape pixel (the pixel position with the “X”) is the first escape pixel within dashed lines 280 in scanning order, then the maximum possible coded copy above run-length is five.

In some examples, video decoder 30 may only determine the run mode (e.g., the palette mode in which the pixels are coded) for the pixels within dashed lines 280. Hence, in the worst case, video decoder 30 makes the determination for BlockWidth−1 pixels. In some examples, video decoder 30 may be configured to implement certain restrictions regarding the maximum of number of pixels for which the run mode is checked. For example, video decoder 30 may only check the pixels within dashed lines 280 if the pixels are in the same row as the current pixel. Video decoder 30 may infer that all other pixels within dashed lines 280 are not coded as escape samples. The example in FIG. 6 assumes a raster scanning order. The techniques however, may be applied to other scanning orders, such as vertical, horizontal traverse, and vertical traverse.

Joshi et al., “Non-SCCE3: Contexts for coding index runs,” Joint Collaborative Team on Video Coding (JCT-VC) of ITU-T SG 16 WP 3 and ISO/IEC JTC 1/SC 29/WG 11, 18th Meeting, Sapporo, JP, 30 Jun.-9 Jul. 2014, document no. JCTVC-R0174 (hereinafter, JCTVC-R0174) proposed to make the contexts of the run-length codewords depend on the index if ‘copy left’ mode is used.

However, in accordance with an example of this disclosure, if the current run mode is ‘copy above,’ the run-length's contexts depend on the index value of its above neighboring pixel's index. In this example, if its above neighboring pixel is outside of the current CU, is the video decoder assumes that the corresponding index equals to a predefined constant k. In some examples, k=0.

During entropy coding, an entropy encoder or decoder may place bits of a symbol to be encoded or decode into one or more bins. The bins indicate whether a value of a symbol is equal to zero. The entropy coder or entropy decoder may use the values of the bins to adjust entropy coding process. In some examples, an entropy encoder or decoder may also use bins to indicate whether a values is greater than a specific value, e.g., greater than zero, greater than one, etc.

In some examples, if the current mode is ‘copy above,’ the first bin of the run-length codeword selects one of the two candidate CABAC contexts based on whether its above neighbor equals to 0 or not.

As another example, if the current mode is ‘copy previous,’ the first bin of the run-length codeword selects one of the four candidate CABAC contexts based on whether the index equals to 0, equals 1, equals to 2, or larger than 2.

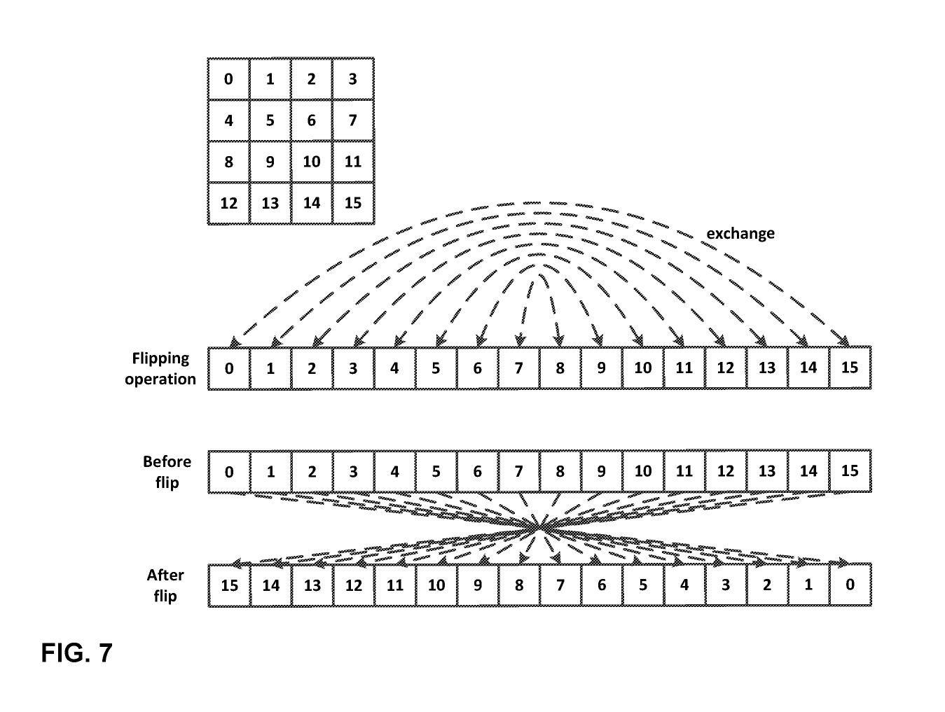

FIG. 7 illustrates an example of swapping (e.g., flipping) samples in accordance with the techniques of this disclosure. In various examples of this disclosure, video encoder 20 and video decoder 30 may respectively encode and decode one or more flags related to the scan order of a block of samples. The one or more flags may be signaled at the CTU, TU, CU, PU, SPS, PPS, or another level of a coded video bitstream.

When performing palette mode coding, video encoder 20 and video decoder 30 may, in some examples, traverse a block of samples (e.g., a block of palette index values) in either a horizontal serpentine (snake-like) traversal scan order or a vertical serpentine (snake-like) traversal scan order. The scan order indicates the order in which the samples (e.g., palette index values) of the block are to be run-length coded during palette mode coding. Whether video encoder 20 or video decoder 30 selects, for example, a vertical or a horizontal traversal scan order for a CU is indicated by the palette_transpose_flag, which may be encoded by video encoder 20 and decoded by video decoder 30 at the CU level.

In accordance with the techniques of this disclosure, video encoder 20 or video decoder 30 may be further configured to code another flag, e.g., at the CU level, which may be referred to as the palette_flip_flag flag. If the value of the palette_flip_flag is true (e.g., equal to a value of one or equal to a value representing true), video encoder 20 and video decoder 30 may swap (flip) the scan ordering of the samples either before or after traversing the block of samples. If palette_flip_flag is enabled (e.g., when the value of the palette_flip_flag is true), video encoder 20 or video decoder 30 may be configured to swap (flip) the samples of a block of samples according to the following equation: Sample[cIdx][x][y]=Sample[cIdx][nCbS−x−1][nCbS−y−1]. In this equation, cIdx is a color component index and indicates which chroma channel (e.g., Cb or Cr) is selected, and x and y are the x and y coordinates of a sample within the block of samples. nCbs denotes the size of the current luma coding block. For a typical 4:2:0 YCbCr-coded block, there are 4 luma samples for every chroma sample; thus the size of the block is equal to four.

Referring to the example shown in FIG. 7, the exemplary samples block (e.g., palette block) has 16 samples labeled 0-15, where the upper-left coordinate has an x-coordinate equal to 0 and a y-coordinate equal to 0. In the example shown, the top-left chroma sample at coordinates (0,0) is swapped (flipped) with the sample at (3, 3), i.e., sample 0 is swapped with sample 15 based on the above equation. The series of arrows in FIG. 7 is a more complete illustration of the swapping of sample positions before and after performing the flipping (swapping) operation, i.e., “Before flip” and “After flip.” In some examples, the illustrated samples may be palette indices.

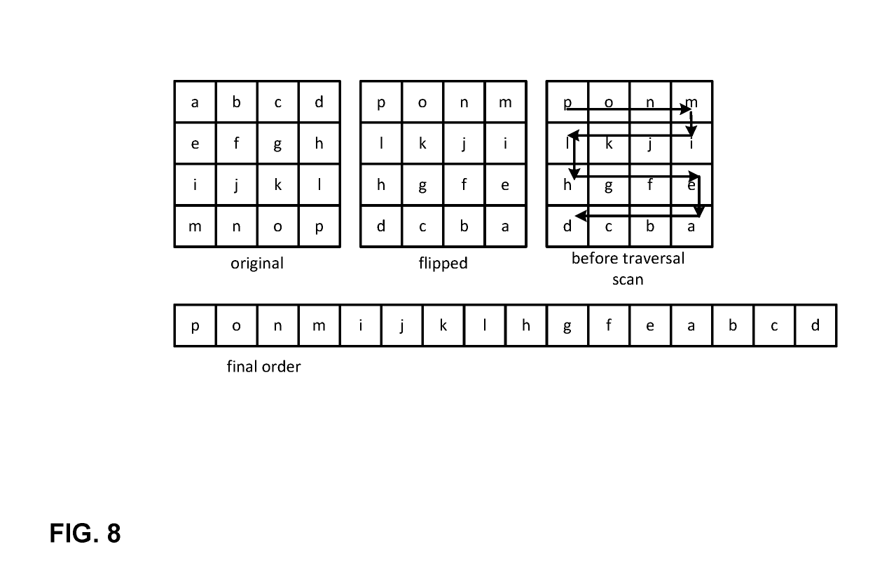

FIG. 8 illustrates an example of swapping (e.g., flipping) a palette mode scan order before performing a specified traversal scan order in accordance with the techniques of this disclosure. In the example of FIG. 8, a block of 16 samples (e.g., a palette block with 16 palette index values) is illustrated as samples a through p. In some examples, the illustrated samples may be palette indices (sometimes referred to as palette index values).

Video encoder 20 and/or video decoder 30 may be configured to apply the swapping operation to samples of a block (e.g., palette index values of a palette block) before traversing the samples according to the specified scan order (e.g., the scan order indicated by the palette_transpose_flag). In some examples, video encoder 20 and/or video decoder 30 may be configured to apply the swapping operation to samples of a block before traversing the samples according to the specified scan order as shown in FIG. 8 if the palette_flip_flag is set (e.g., equal to a value of one or equal to a value representing true). In the example shown, the specified scan order may be a horizontal traversal scan order. For example, if video encoder 20 and/or video decoder 30 apply the swapping operation to the samples before traversing the samples in the scan order, one exemplary result is illustrated in FIG. 8. Otherwise stated, the scan order may effectively become “ponmijklhgfeabcd,” meaning that the samples are traversed according to the “ponmijklhgfeabcd” scan order instead of the “abcdefghijklmnop” scan order. In other examples, the specified scan order may be a vertical traversal scan order. In such examples, the scan order may effectively become “plhdcgkonjfbaeim,” meaning that the samples are traversed according to the “plhdcgkonjfbaeim” scan order instead of the “aelmnjfbcgkoplhd” scan order.

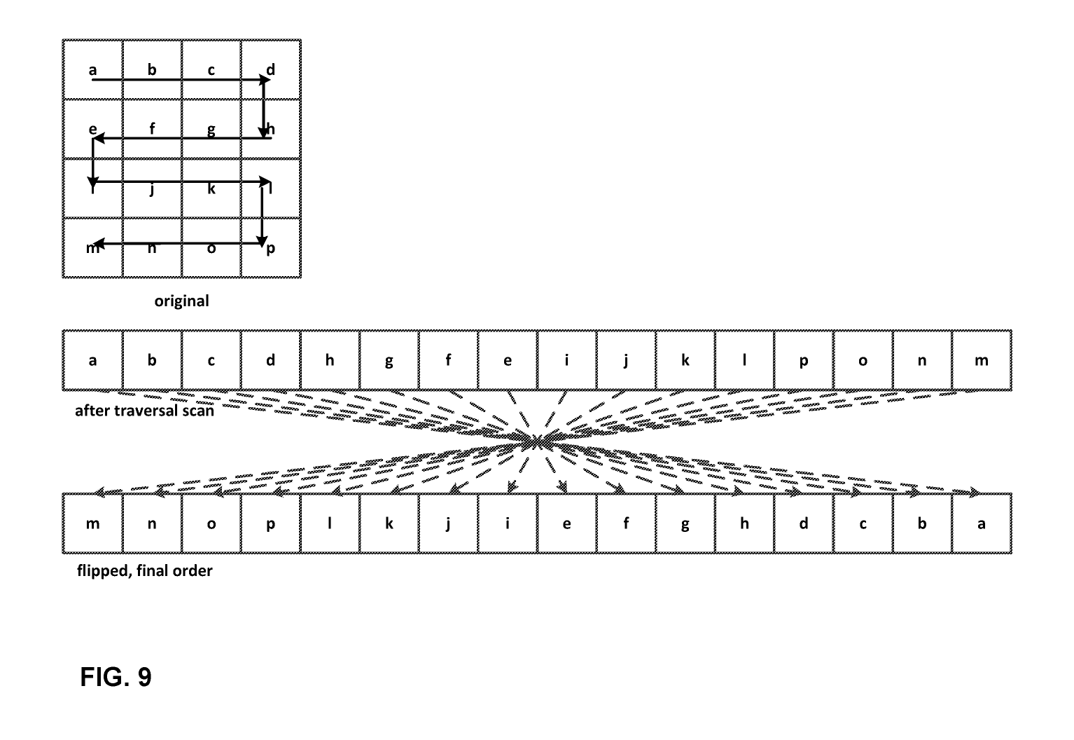

FIG. 9 illustrates an example of swapping (e.g., flipping) samples (e.g., palette index values) of a block of samples (e.g., a palette block) after traversing the samples in accordance with the techniques of this disclosure. In the example of FIG. 9, a block of 16 samples is illustrated as samples a through p. In some examples, the illustrated samples may be palette indices (sometimes referred to as palette index values).

Video encoder 20 and/or video decoder 30 may be configured to apply the swapping operation to samples of a block after traversing the samples according to the specified scan order (e.g., the scan order indicated by the palette_transpose_flag). In some examples, video encoder 20 and/or video decoder 30 may be configured to apply the swapping operation to samples of a block after traversing the samples according to the specified scan order as shown in FIG. 9 if the palette_flip_flag is set (e.g., equal to a value of one or equal to a value representing true). In the example shown, the specified scan order may be a horizontal traversal scan order. For example, if video encoder 20 and/or video decoder 30 apply the swapping operation to the samples after traversing the samples in the scan order, one exemplary result is illustrated in FIG. 9. Otherwise stated, the final sample ordering after traversal and after performing flipping after traversal in the example of FIG. 9 is “mnoplkjiefghdcba.”

As used herein, a scan order may be referred to as a scan, a scan ordering, and the like. As used herein, a horizontal scan order may refer to a forward or reverse horizontal scan order. Similarly, as used herein, a vertical scan order may refer to a forward or reverse horizontal scan order. In some examples, vertical scan orders may require extra operations to access consecutive pixels or equivalent of a transpose operation.

In some examples, video encoder 20 and/or video decoder 30 may be configured to use a horizontal traverse scan order instead of a vertical traverse scan order to reduce the number of operations that would otherwise exist by virtue of using the vertical traverse scan order. For example, video encoder 20 and/or video decoder 30 may be configured to use a horizontal traverse scan order flipped after scanning (e.g., the scan order described with respect to FIG. 9) instead of a vertical scan order. In such an example, video encoder 20 and/or video decoder 30 may be configured to apply the swapping operation to samples of a block after traversing the samples according to a horizontal scan order instead of a vertical scan order if the value of the syntax element palette_transpose_flag is set (e.g., equal to a value of one or equal to a value representing true), as shown in the example of FIG. 9. Otherwise stated, instead of the palette_transpose_flag indicating either a horizontal scan order or a vertical scan order, the palette_transpose_flag may indicate either a horizontal scan order or a flipped horizontal scan order (e.g., flipped after scanning).

In other examples, instead of using a flipped horizontal scan, the scan based on the palette_transpose_flag may be a horizontal raster scan without flipping after scanning. In such examples, instead of the palette_transpose_flag indicating either a horizontal scan order or a vertical scan order, the palette_transpose_flag may indicate either a horizontal traverse scan order or a horizontal raster scan order.

In other examples, a total of four scan orders may be available, which may include two vertical scan order options. In such examples, forward and reverse vertical traverse scan orders may be replaced with forward and reverse horizontal raster scan orders. For example, the vertical traverse scans (forward and reverse) in JCTVC-T0119 are replaced by horizontal raster scans (forward and reverse). As another example, the vertical scans in JCTVC-T0174 may be replaced by horizontal raster scans (forward and rotated by 180 degrees). In these examples, the signaling proposed in JCTVC-T0119 and JCTVC-T0174, respectively, may be maintained or a different signaling may be used to indicate which of the four scans is used.

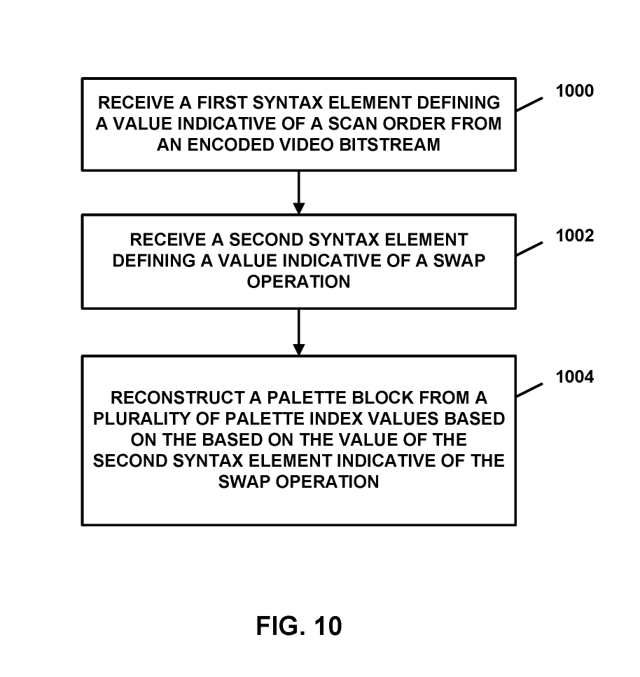

FIG. 10 is a flowchart illustrating an example process for decoding video data consistent with techniques of this disclosure. The process of FIG. 10 is generally described as being performed by video decoder 30 for purposes of illustration, although a variety of other processors may also carry out the process shown in FIG. 10. In some examples, block decoding unit 152, palette-based decoding unit 165, and/or entropy decoding unit 150 may perform one or more processes shown in FIG. 10.

In the example of FIG. 10, video decoder 30 may be configured to decode video data using palette mode. Video decoder 30 may be configured to a first syntax element defining a value indicative of a scan order (1000). For example, video decoder 30 may be configured to a first syntax element defining a value indicative of a scan order from an encoded video bitstream. Video decoder 30 may be configured to receive a second syntax element defining a value indicative of a swap operation (1002). For example, video decoder 30 may be configured to receive a second syntax element defining a value indicative of a swap operation from an encoded video bitstream.

Video decoder 30 may be configured to reconstruct a palette block from a plurality of palette index values based on the value of the second syntax element indicative of the swap operation (1004). In some examples, the first syntax element may include the palette_transpose_flag syntax element described herein and the second syntax element may include the palette_flip_flag syntax element described herein.

In some examples, the block of video data is a coding unit or a prediction unit. In some examples, video decoder 30 may be configured to reconstruct the palette block by being configured to swap, according to the swap operation, a first palette index value of the plurality of palette index values having a first scan position with a second palette index value of the plurality of palette index values having a second scan position before or after processing the plurality of palette index values according to the scan order. In some examples, video decoder 30 may be configured to reconstruct the palette block by being configured to swap, according to the swap operation, each palette index value of the plurality of palette index values with another palette index value of the plurality of palette index values before or after processing the plurality of palette index values according to the scan order.

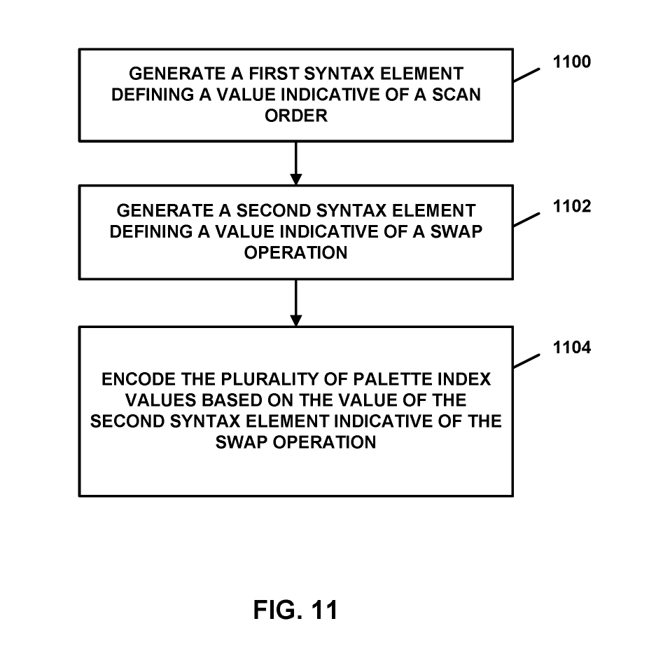

FIG. 11 is a flowchart illustrating an example process for encoding video data consistent with techniques of this disclosure. The process of FIG. 11 is generally described as being performed by video encoder 20 for purposes of illustration, although a variety of other processors may also carry out the process shown in FIG. 11. In some examples, block encoding unit 100, palette-based encoding unit 122, and/or entropy encoding unit 118 may perform one or more processes shown in FIG. 11.

In the example of FIG. 11, video encoder 20 may be configured to encode a palette block of video data having a plurality of palette index values using palette mode. Video encoder 20 may be configured to a first syntax element defining a value indicative of a scan order (1100). Video encoder 20 may be configured to generate a second syntax element defining a value indicative of a swap operation (1102). Video encoder 20 may be configured to encode the plurality of palette index values based on the value of the second syntax element indicative of the swap operation (1104). In some examples, the first syntax element may include the palette_transpose_flag syntax element described herein and the second syntax element may include the palette_flip_flag syntax element described herein.

In some examples, video encoder 20 may be configured to encode the plurality of palette index values based on the value of the second syntax element indicative of the swap operation by being configured to swap, according to the swap operation, a first palette index value of the plurality of palette index values having a first scan position with a second palette index value of the plurality of palette index values having a second scan position before or after processing the plurality of palette index values according to the scan order. In some examples, video encoder 20 may be configured to encode the plurality of palette index values based on the value of the second syntax element indicative of the swap operation by being configured to swap, according to the swap operation, each palette index value of the plurality of palette index values with another palette index value of the plurality of palette index values before or after processing the plurality of palette index values according to the scan order.

### Example 1

A method of processing video data according to any of the techniques or any combination or permutation of the techniques disclosed herein.

### Example 2

A method of coding video data, the method comprising: determining a symbol associated with a binary palette prediction vector or a run-length coded index map in palette for a coding unit (CU); and entropy coding the symbol using a using a k^{th} order non-uniform truncated exponential-Golomb (TEGk) code, wherein the TEGk code comprises a unary prefix and a unary suffix.

### Example 3

The method of example 2, wherein entropy coding comprises entropy encoding.

### Example 4

The method of example 2, wherein entropy coding comprises entropy decoding.

### Example 5

The method of example 2, further comprising: responsive to determining that the symbol is equal to a maximum possible value for the symbol, setting the suffix equal to 1, and responsive to determining that the symbol is not equal to a maximum possible value for the symbol: calculating the suffix as “0” concatenated with the binary representation of x−2^{k}(2^{l(x)}−1), wherein x is a given unsigned integer symbol, wherein the prefix is a unary code equal to: of

$$l ( x ) = ⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

if the prefix is truncated, wherein k is an order of the Exponential-Golomb Code, wherein the suffix has k+l(x) bits.

### Example 6

The method of example 5 wherein the maximum symbol value for the input of truncated binary code is equal to: X−2^{k}(2^{l(x)}−1)−1, wherein x is a given unsigned integer symbol, wherein the prefix is a unary code equal to: of l(x)=

$$⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

if the prefix is truncated, wherein k is an order of the Exponential-Golomb Code, wherein the suffix has k+l(x) bits.

### Example 7

The method of example 2, further comprising: responsive to determining that the symbol is equal to a maximum possible value for the symbol, setting the suffix equal to 0, and responsive to determining that the symbol is not equal to a maximum possible value for the symbol: calculating the suffix as “1” concatenated with the binary representation of x−2^{k}(2^{l(x)}−1), wherein x is a given unsigned integer symbol, wherein the prefix is a unary code equal to: of

$$l ( x ) = ⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

if the prefix is truncated, wherein k is an order of the Exponential-Golomb Code, wherein the suffix has k+l(x) bits.

### Example 8

The method of example 6, wherein the maximum symbol value for the input of truncated binary code is equal to: X−2^{k}(2^{l(x)}−1)−1, wherein x is a given unsigned integer symbol, wherein the prefix is a unary code equal to: of l(x)=

$$⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

if the prefix is truncated, wherein k is an order of the Exponential-Golomb Code, wherein the suffix has k+l(x) bits.

### Example 9

The method of example 2, responsive to determining that the symbol is equal to a maximum possible value for the symbol, setting the suffix equal to 1, and responsive to determining that the symbol is not equal to a maximum possible value for the symbol: calculating the suffix as “0” concatenated with the fixed length representation of x−2^{k}(2^{l(x)}−1), wherein x is a given unsigned integer symbol, wherein the prefix is a unary code equal to: of

$$l ( x ) = ⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

it the prefix is truncated, wherein k is an order of the Exponential-Golomb Code, wherein the suffix has k+l(x) bits.

### Example 10

The method of example 2, wherein the maximum symbol value for the input of truncated binary code is equal to: X−2^{k}(2^{l(x)}−1)−1, wherein x is a given unsigned integer symbol, wherein the prefix is a unary code equal to: of

$$l ( x ) = ⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

if the prefix is truncated, wherein k is an order of the Exponential-Golomb Code, wherein the suffix has k+l(x) bits.

### Example 11

The method of example 2, further comprising: responsive to determining that the symbol is equal to a maximum possible value for the symbol, setting the suffix equal to 1, and responsive to determining that the symbol is not equal to a maximum possible value for the symbol: calculating the suffix as “0” concatenated with the fixed length representation of x−2^{k}(2^{l(x)}−1), wherein x is a given unsigned integer symbol, wherein the prefix is a unary code equal to: of

$$l ( x ) = ⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

it the prefix is truncated, wherein k is an order of the Exponential-Golomb Code, wherein the suffix has k+l(x) bits.

### Example 12

The method of example 11, wherein the maximum symbol value for the input of fixed length code is equal to: X−2^{k}(2^{l(x)}−1)−1, wherein x is a given unsigned integer symbol, wherein the prefix is a unary code equal to: of

$$l ( x ) = ⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

if the prefix is truncated, wherein k is an order of the Exponential-Golomb Code, wherein the suffix has k+l(x) bits.

### Example 13

the method of example 2, further comprising: responsive to determining that the symbol is equal to a maximum possible value for the symbol, setting the suffix equal to 0, and responsive to determining that the symbol is not equal to a maximum possible value for the symbol: calculating the suffix as “1” concatenated with the fixed length representation of x−2^{k}(2^{l(x)}−1), wherein x is a given unsigned integer symbol, wherein the prefix is a unary code equal to: of

$$l ( x ) = ⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

if the prefix is truncated, wherein k is an order of the Exponential-Golomb Code, wherein the suffix has k+l(x) bits.

### Example 14

the method of example 13, wherein the maximum symbol value for the input of fixed length code is equal to: X−2^{k}(2^{l(x)}−1)−1, wherein x is a given unsigned integer symbol, wherein the prefix is a unary code equal to: of l(x)=

$$⌊ {log}_{2} ( \frac{x}{{2}^{k}} + 1 ) ⌋$$

when not truncated, and

$$⌊ {log}_{2} ( \frac{X}{{2}^{k}} + 1 ) ⌋ == l ( x )$$

if the prefix is truncated, wherein k is an order of the Exponential-Golomb Code, wherein the suffix has k+l(x) bits.

### Example 15

the method of example 2, wherein the symbol comprises part of a syntax element, the method further comprising: coding a first occurrence of the syntax element using a truncated exponential Golomb code; and coding a subsequent occurrence of the syntax element using a non-uniform truncated exponential Golomb code or a simplified non-uniform truncated exponential Golomb Code.

### Example 16

the method of example 15, wherein the syntax element comprises a part of a run-length coded binary palette prediction vector, wherein a maximum run-length value X, of the run-length coded binary palette prediction vector is equal to a number of palette entries in a palette predictor list−current position in scanning order−1).

### Example 17

the method of example 16, wherein the non-uniform truncated exponential Golomb code comprises a non-uniform TEG0 code.

### Example 18

the method of example 2, wherein the symbol comprises part of a syntax element, the method further comprising further comprising: coding a first occurrence of the syntax element using a truncated exponential Golomb code; and coding a subsequent occurrence of the syntax element using a non-uniform truncated exponential Golomb code or a simplified non-uniform truncated exponential Golomb Code.

### Example 19

the method of example 2, wherein the symbol is associated with a run-length coded sample index map for a palette, wherein a maximal run value X for the index map is equal to: a number of pixels in a current CU minus a current position in a scanning order−1.

### Example 20

the method of example 19, wherein the non-uniform TEGk code comprises a 2^{nd} order non-uniform TEGk code (TEG2).

### Example 21

the method of example 2, wherein the symbol is associated with a run-length coded index map for a palette, wherein a maximal run value X for the index map is equal to: a number of pixels in a current CU minus a current position in a scanning order−1.

### Example 22

the method of example 21, further comprising: coding the run-length using a greater than 0 bin, a greater than 1 bin, and a greater than 2 bin; and when the run-length is greater than 2, coding a remaining portion of the run-length using a non-uniform truncated exponential-Golomb (TEGk) code, wherein the maximum run-length is equal to: a number of pixels in a current CU−a current position in a scanning order−4.

### Example 23

the method of example 22, wherein the non-uniform truncated exponential-Golomb code comprises a 2^{nd} order non-uniform truncated exponential Golomb code (TEG2).

### Example 24

the method of example 22, wherein the prefix of the non-uniform truncated exponential-Golomb code comprises: a one bit truncated unary prefix specifying whether a syntax element indicating a run of the palette is equal to zero; and a 0th order non-uniform truncated exponential Golomb code (TEG0) if the syntax element indicating the run is not equal to zero.

### Example 25

the method of example 2, wherein the symbol comprises a symbol of the palette, wherein entropy coding the symbol using a non-uniform TEGk code further comprises: entropy coding a run of copy above-coded pixels of the index map using a non-uniform TEGk, wherein a maximum sample length of the run of copy above-coded pixels is equal to L−1, wherein L is a non-escaped pixel having an above-neighboring escaped pixel, l, or L is equal to a pixel position after a last pixel of a block of the CU in a scanning order for the block.

### Example 26

the method of example 24, wherein the symbol comprises a symbol of the palette, wherein entropy coding the symbol further comprises: responsive to determining that the unary prefix is indicated by bins that indicate if the unary prefix is greater than zero, greater than 1, or greater than 2, setting the maximum sample run-length of the copy above-coded pixels equal to L−4.

### Example 27

the method of example claim 25, wherein the symbol comprises a symbol of the palette, wherein entropy coding the symbol further comprises: responsive to determining that the unary prefix is indicated by bins that indicate if the unary prefix is greater than zero, setting the maximum sample run-length of the copy above-coded pixels equal to L−2.

### Example 28

the method of example 1, wherein coding the suffix is optional.

### Example 29

the method of example 1, further comprising: entropy coding a non-uniform exponential Golomb code (EGk) comprising a coding unary suffix and coding an optional suffix, wherein coding the optional suffix comprises: responsive to determining whether a values is less than 2^{k}(2^{l(x)+1}−1): coding a flag to indicate whether X==x; and coding a fixed length code representation of x−2ₖ(2^{l(x)}−1) if X≠x, and responsive to determining that X>x: coding a fixed length code representation of x−2^{k}(2^{l(x)}−1), wherein X is a maximum value that can possibly be coded, wherein x is a given unsigned integer symbol, wherein k is an order of the Exponential-Golomb Code, and wherein the suffix has k+l(x) bits.

### Example 30

the method of example 1, further comprising: entropy coding a non-uniform truncated exponential Golomb Code (TEGk) or a non-uniform exponential Golomb code (EGk) comprising coding a unary suffix and coding an optional suffix, wherein coding the optional suffix comprises: coding a flag to indicate whether X==x, and coding a fixed length code representation of x−2^{k}(2^{l(x)}−1) if X≠x, wherein X is a maximum value that can possibly be coded, wherein x is a given unsigned integer symbol, wherein k is an order of the Exponential-Golomb Code, and wherein the suffix has k+l(x) bits.

### Example 31

A method of decoding video data, the method comprising: obtaining, from a bitstream that comprises an encoded representation of the video data, an Exponential-Golomb (Exp-Golomb) code for a value x, the Exp-Golomb code comprising a unary prefix and a suffix, wherein: when the value x is less than 2^{k}(2^{l(x)+1}−1), the suffix comprises: a flag that indicates whether X==x, and if X≠x, a fixed length code representation of x−2^{k}(2^{l(x)}−1); and when X>x, the suffix value comprises the fixed length code representation of x−2^{k}(2^{l(x)}−1), wherein X is a maximum possible value of x, wherein x is an unsigned integer symbol, wherein k is an order of the Exponential-Golomb Code, and

$$l ( x ) = ⌊ {log}_{2} ( \frac{x}{{2}^{k}} + 1 ) ⌋ .$$

### Example 32

A method of encoding video data, the method comprising: including, in a bitstream that comprises an encoded representation of the video data, an Exponential-Golomb (Exp-Golomb) code for a value x, the Exp-Golomb code comprising a unary prefix and a suffix, wherein: when the value x is less than 2^{k}(2^{l(x)+1}−1), the suffix comprises: a flag that indicates whether X==x, and if X≠x, a fixed length code representation of x−2^{k}(2^{l(x)}−1), when X>x, the suffix comprises the fixed length code representation of x−2^{k}(2^{l(x)}−1), wherein X is a maximum possible value of x, wherein x is an unsigned integer symbol, wherein k is an order of the Exponential-Golomb Code, and

$$l ( x ) = ⌊ {log}_{2} ( \frac{x}{{2}^{k}} + 1 ) ⌋ .$$

### Example 33

A method of decoding video data, the method comprising: obtaining, from a bitstream that comprises an encoded representation of the video data, an Exponential-Golomb (Exp-Golomb) code for a value x, the code comprising a unary prefix and a suffix, the suffix comprising: a flag indicating whether X==x, and if X≠x, a fixed length code representation of x−2^{k}(2^{l(x)}−1), wherein: X is a maximum possible value of x, x is an unsigned integer symbol, k is an order of the Exponential-Golomb Code, and

$$l ( x ) = ⌊ {log}_{2} ( \frac{x}{{2}^{k}} + 1 ) ⌋ .$$

### Example 34

A method of encoding video data, the method comprising: including, in a bitstream that comprises an encoded representation of the video data, an Exponential-Golomb (Exp-Golomb) code for a run-length, the run-length indicating a length of a run of index values indicating entries of a palette of a coded unit (CU) of the video data, the Exp-Golomb code comprising a unary prefix and a suffix, wherein: the Exp-Golomb coding having a particular value indicates the run reaches an end of a coding block for the CU.

### Example 35

The method of example 34, wherein the particular value is a fixed codeword.

### Example 36

the method of example 34, if the run reaches the end of the coding block for the CU, the prefix is coded such that 2^{k}(2ₗ₍ₓ₎−1)≧X, X is a maximum possible value of x, x is an unsigned integer symbol, k is an order of the Exponential-Golomb Code, and

$$l ( x ) = ⌊ {log}_{2} ( \frac{x}{{2}^{k}} + 1 ) ⌋ .$$

### Example 37

A method of encoding video data, the method comprising: including, in a bitstream that comprises an encoded representation of video data, an encoded syntax element that indicates whether a palette-mode-coded coding unit (CU) of the video data is traversed in a horizontal serpentine scan order or a vertical serpentine scan order; and encoding the CU, wherein the horizontal serpentine scan order alternates left-to-right and right-to-left on a line-by-lines basis of the CU, and wherein the vertical serpentine scan order alternates top-to-bottom and bottom-to-top on a line-by-line basis of the CU.

### Example 38

A method of encoding video data, the method comprising: including, in a bitstream that comprises an encoded representation of the video data, an encoded syntax element that indicates whether a palette of a palette-mode-coded coding unit (CU) traversed in a flipped scan order, wherein the flipped scan order has reversed vertical and horizontal sample positions.

### Example 39

A method of decoding video data, the method comprising: obtaining, from a bitstream that comprises an encoded representation of the video data, an Exponential-Golomb (Exp-Golomb) code for a run-length, the run-length indicating a length of a run of index values indicating entries of a palette of a coding unit (CU) of the video data, the Exp-Golomb code comprising a unary prefix and a suffix, wherein: the Exp-Golomb code having a particular value indicates the run reaches an end of a coding block for the CU.

### Example 40

The method of example 38, wherein the particular value is a fixed codeword.

### Example 41

The method of example 39, wherein: if the run-length is larger than the fixed codeword, determining that the run-length is equal to the run-length−1.

### Example 42

The method of example 38, wherein: if the run reaches the end of the coding block for the CU, the prefix is coded such that 2^{k}(2^{l(x)}−1)≧X, X is a maximum possible value of x, x is an unsigned integer symbol, k is an order of the Exponential-Golomb Code, and

$$l ( x ) = ⌊ {log}_{2} ( \frac{x}{{2}^{k}} + 1 ) ⌋ .$$

### Example 43

A method of decoding video data, the method comprising:

obtaining, from a bitstream that comprises an encoded representation of the video data, an encoded syntax element from the video data that indicates whether a palette of a palette-mode-coded coding unit (CU) of the video data is traversed in a horizontal serpentine scan order or a vertical serpentine scan order; and traversing the palette in the horizontal serpentine scan order or the vertical serpentine scan order based on the syntax element that indicates whether the palette is traversed in the horizontal serpentine scan order or the vertical serpentine scan order, wherein the horizontal serpentine scan order alternates left-to-right and right-to-left on a line-by-lines basis of the CU, and wherein the vertical serpentine scan order alternates top-to-bottom and bottom-to-top on a line-by-line basis of the CU.

### Example 44

A method of decoding video data, the method comprising: obtaining, from a bitstream that comprises an encoded representation of the video data an encoded syntax element from the video data that indicates whether a palette of a palette-mode-coded coding unit (CU) of the video data is traversed in a flipped scan order, wherein the flipped scan order has reversed vertical and horizontal sample positions; and traversing the palette in the flipped scan order based on the syntax element that indicates whether the palette is traversed in the flipped scan order.

### Example 45

A method of encoding video data, the method comprising: including, in a bitstream, an Exponential-Golomb (Exp-Golomb) code for a value x, the code comprising a unary prefix and a suffix, the suffix comprising: a flag indicating whether X==x; and if X≠x, a fixed length code representation of x−2^{k}(2^{l(x)}−1), wherein: X is a maximum possible value of x, x is an unsigned integer symbol, k is an order of the Exponential-Golomb Code, and

$$l ( x ) = ⌊ {log}_{2} ( \frac{x}{{2}^{k}} + 1 ) ⌋ .$$

### Example 46

A method of encoding video data, the method comprising: palette mode encoding, by a video encoder, a coding unit (CU) of video data, wherein palette mode coding the CU comprises: traversing, by the video encoder, a block of samples of the CU in a scan order, wherein the scan order indicates an order in which the samples are traversed, by the video encoder, when encoding the block, generating, by the video encoder, a flag syntax element, wherein the flag syntax element indicates whether the samples in the scan order have been swapped with other samples from the block before or after performing the traversal, entropy encoding a representation of the flag syntax element in an encoded video bitstream, and encoding, by the video encoder, the block of samples based on the samples and the scan order indicated by the flag.

### Example 47

A method of decoding video data, the method comprising: palette mode decoding, by a video decoder, a coding unit (CU) of video data, wherein palette mode coding the CU comprises: receiving, by the video decoder, and in an encoded video bitstream, a representation of a flag syntax element, traversing, by the video decoder, a block of samples of the CU in a scan order, wherein the scan order indicates an order in which the samples are traversed, by the video decoder, when decoding the block, entropy decoding the representation of the flag syntax element to determine a value of the flag syntax element, wherein the value of the flag syntax element indicates whether the samples in the scan order have been swapped with other samples from the block before or after performing the traversal, and decoding, by the video decoder, the block of samples based on the samples and the scan order indicated by the value of the flag syntax element.

### Example 48

The method of any of examples 46-47, further comprising: swapping, by the video coder, the samples of the block, based on the following equation:

Sample[cIdx][x][y]=Sample[cIdx][nCbS−x−1][nCbS−y−1],

wherein cIdx is an index of a color component, wherein nCbs is a luma size of the block, wherein x is an x-coordinate of a sample of the block, and wherein y is a y-coordinate of the sample of the block.

### Example 49

A method of encoding video data, the method comprising: palette mode encoding, by a video encoder, a coding unit (CU) of video data, wherein palette mode encoding the CU comprises: traversing, by the video encoder, a block of samples of the CU in a scan order that is not a vertical traverse scan order, wherein the scan order indicates an order in which the samples are traversed, by the video encoder, when encoding the block.

### Example 50

A method of encoding video data, the method comprising: palette mode encoding, by a video encoder, a coding unit (CU) of video data, wherein palette mode encoding the CU comprises: traversing, by the video encoder, a block of samples of the CU in a scan order, wherein the scan order indicates an order in which the samples are traversed, by the video encoder, when encoding the block; and generating, by the video encoder, a flag syntax element, wherein the flag syntax element indicates the scan order is not a vertical traverse scan order.

### Example 51

A method of encoding video data, the method comprising: palette mode encoding, by a video encoder, a coding unit (CU) of video data, wherein palette mode encoding the CU comprises: traversing, by the video encoder, a block of samples of the CU in a scan order, wherein the scan order indicates an order in which the samples are traversed, by the video encoder, when encoding the block; generating, by the video encoder, a flag syntax element, wherein the flag syntax element indicates the scan order is not a vertical traverse scan order; entropy encoding a representation of the flag syntax element in an encoded video bitstream; and encoding, by the video encoder, the block of samples based on the samples and the scan order indicated by the flag.

### Example 52

The method of any combination of examples 50-51, wherein the flag syntax element indicates whether the samples in the scan order have been swapped with other samples from the block before or after performing the traversal.

### Example 53

The method of any combination of examples 50-52, wherein the scan order is a forward or reverse horizontal traverse scan order.

### Example 54

The method of any combination of examples 50-52, wherein the scan order is a forward or reverse horizontal traverse scan order flipped before or after scanning.

### Example 55

A method of decoding video data, the method comprising: palette mode decoding, by a video decoder, a coding unit (CU) of video data, wherein palette mode decoding the CU comprises: traversing, by the video decoder, a block of samples of the CU in a scan order that is not a vertical traverse scan order, wherein the scan order indicates an order in which the samples are traversed, by the video decoder, when decoding the block.

### Example 56

A method of decoding video data, the method comprising: palette mode decoding, by a video decoder, a coding unit (CU) of video data, wherein palette mode decoding the CU comprises: receiving, by the video decoder, and in an encoded video bitstream, a representation of a flag syntax element, wherein the flag syntax element is used to indicate a scan order that is not a vertical traverse scan order; and

traversing, by the video decoder, a block of samples of the CU in the scan order, wherein the scan order indicates an order in which the samples are traversed, by the video decoder, when decoding the block.

### Example 57

A method of decoding video data, the method comprising:

palette mode decoding, by a video decoder, a coding unit (CU) of video data, wherein palette mode decoding the CU comprises: receiving, by the video decoder, and in an encoded video bitstream, a representation of a flag syntax element, wherein the flag syntax element is used to indicate a scan order that is not a vertical traverse scan order; traversing, by the video decoder, a block of samples of the CU in the scan order, wherein the scan order indicates an order in which the samples are traversed, by the video decoder, when decoding the block; entropy decoding the representation of the flag syntax element to determine a value of the flag syntax element, wherein the value of the flag syntax element indicates the scan order is not a vertical traverse scan order; and decoding, by the video decoder, the block of samples based on the samples and the scan order indicated by the value of the flag syntax element.

### Example 58

The method of any combination of examples 56-57, wherein the flag syntax element indicates whether the samples in the scan order have been swapped with other samples from the block before or after performing the traversal.

### Example 59

The method of any combination of examples 56-58, wherein the scan order is a forward or reverse horizontal traverse scan order.

### Example 60

The method of any combination of examples 56-58, wherein the scan order is a forward or reverse horizontal traverse scan order flipped before or after scanning.

### Example 61

the method of any combination of examples 2-48, wherein entropy coding comprises entropy encoding.

### Example 62

the method of any combination of examples 2-48, wherein entropy coding comprises entropy decoding.

### Example 63

A method of decoding video data using palette mode, the method comprising: receiving a palette mode encoded block of video data of a picture; receiving encoded palette mode information for the palette mode encoded block of video data, wherein the encoded palette mode information is encoded according to a kth order non-uniform truncated exponential-Golomb (TEGk) coding scheme and includes a unary prefix code word and a suffix code word; entropy decoding the encoded palette mode information using the kth order non-uniform truncated exponential-Golomb (TEGk) coding scheme, wherein the kth order non-uniform TEGk coding scheme is different from a kth order exponential-Golomb (EGk) coding scheme and a kth order truncated exponential-Golomb (TEGk) coding scheme; and decoding the palette mode encoded block of video data using the decoded palette mode information.

### Example 64

The method of example 63, wherein the block of video data is a coding unit or a prediction unit.

### Example 65

The method of example 63, wherein the encoded palette mode information includes an encoded binary palette prediction vector or an encoded run-length value.

### Example 66

The method of example 63, wherein the encoded palette mode information includes an end-run flag having a value, wherein the value of the end-run flag represents a likelihood of a run-length for the palette mode encoded block of video data going to the end of the palette mode encoded block of video data.

### Example 67

The method of example 63, wherein the encoded palette mode information only includes an end-run flag having a value when the unary prefix code word is truncated, wherein the value of the end-run flag represents a likelihood of a run-length for the palette mode encoded block of video data going to the end of the palette mode encoded block of video data.

### Example 68

The method of example 63, wherein the unary prefix code word is truncated and the suffix code word is “1” if X==x, where x is an unsigned integer symbol corresponding to run-length and X is a maximum possible value of x.

### Example 69

The method of example 68, wherein the encoded palette mode information includes an end-run flag having a value representative of whether X==x.

### Example 70

The method of example 68, wherein the encoded palette mode information only includes an end-run flag having a value if X==x.

### Example 71

A method comprising any combination of examples 63-70

### Example 72

A method of encoding video data using palette mode, the method comprising: encoding a block of video data using palette mode, wherein encoding the block of video data using palette mode comprises: generating palette mode information for the block of video data; and entropy encoding the palette mode information using a kth order non-uniform truncated exponential-Golomb (TEGk) coding scheme resulting in a unary prefix code word and a suffix code word, wherein the kth order non-uniform TEGk coding scheme is different from a kth order exponential-Golomb (EGk) coding scheme and a kth order truncated exponential-Golomb (TEGk) coding scheme.

### Example 73

The method of example 72, wherein the block of video data is a coding unit or a prediction unit.

### Example 74

The method of example 72, wherein the palette mode information includes a binary palette prediction vector or a run-length value.

### Example 75

The method of example 72, wherein the palette mode information includes an end-run flag having a value, wherein the value of the end-run flag represents a likelihood of a run-length for the block of video data going to the end of the block of video data.

### Example 76

The method of example 72, wherein the palette mode information only includes an end-run flag having a value when the unary prefix code word is truncated, wherein the value of the end-run flag represents a likelihood of a run-length for the block of video data going to the end of the block of video data.

### Example 77

The method of example 72, wherein the unary prefix code word is truncated and the suffix code word is “1” if X==x, where x is an unsigned integer symbol corresponding to run-length and X is a maximum possible value of x.

### Example 78

The method of example 77, wherein the palette mode information includes an end-run flag having a value representative of whether X==x.

### Example 79

The method of example 77, wherein the palette mode information only includes an end-run flag having a value if X==x.

### Example 80

A method comprising any combination of examples 72-79.

### Example 81

A method of processing video data according to any of the techniques or any combination or permutation of the techniques disclosed herein.

### Example 82

A method of coding video data, the method comprising: coding syntax element that indicates a particular technique for palette run coding; and coding video data in accordance with the syntax element.

### Example 83

A method of coding video data, the method comprising: conditionally coding an end-run flag based on a palette coding mode, wherein the end-run flag indicates if a current run of a run-length syntax element is at an end of a block; and coding video data in accordance with the end-run flag.

### Example 84

The method of example 83, wherein the palette coding mode is an INDEX mode, and wherein coding the end-run flag further comprises coding the end-run flag based a value of a palette index.

### Example 85

The method of example 83, wherein the palette coding mode is a COPY_ABOVE mode, and wherein coding the end-run flag further comprises coding the end-run flag based a value of a palette index of a neighbor block.

### Example 86

A method of coding video data, the method comprising: coding an end-run flag using context-based entropy coding, wherein the end-run flag indicates if a current run of a run-length syntax element is at an end of a block; and selecting a context for the end-run flag based a palette coding mode.

### Example 87

The method of example 86, wherein the palette coding mode is an INDEX mode, and wherein selecting the context further comprises selecting the context based a value of a palette index.

### Example 88

The method of example 86, wherein the palette coding mode is a COPY_ABOVE mode, and wherein selecting the context further comprises selecting the context based a value of a palette index of a neighbor block.

### Example 89

A method of coding video data, the method comprising: conditionally coding an end-run flag based on at least one of a palette size, a coding unit size, a value of a palette_share syntax element, or a value of a palette_transpose syntax element, wherein the end-run flag indicates if a current run of a run-length syntax element is at an end of a block; and coding video data in accordance with the end-run flag.

### Example 90

A method of coding video data, the method comprising: coding an end-run flag using context-based entropy coding, wherein the end-run flag indicates if a current run of a run-length syntax element is at an end of a block; and selecting a context for the end-run flag based on at least one of a palette size, a coding unit size, a value of a palette_share syntax element, or a value of a palette_transpose syntax element.

### Example 91

A method of coding video data, the method comprising: conditionally coding an end-run flag based on a starting position of a current run, wherein the end-run flag indicates if the current run of a run-length syntax element is at an end of a block; and coding video data in accordance with the end-run flag.

### Example 92

A method of coding video data, the method comprising: coding an end-run flag using context-based entropy coding, wherein the end-run flag indicates if a current run of a run-length syntax element is at an end of a block; and selecting a context for the end-run flag based on a starting position of the current run.

### Example 93

A method of coding video data, the method comprising: conditionally coding an end-run flag based on a number of occurrences of a palette run syntax element in a block, wherein the end-run flag indicates if the current run of a run-length syntax element is at an end of the block; and coding video data in accordance with the end-run flag.

### Example 94

A method of coding video data, the method comprising: coding an end-run flag using context-based entropy coding, wherein the end-run flag indicates if a current run of a run-length syntax element is at an end of a block; and selecting a context for the end-run flag based on a number of occurrences of a palette run syntax element in the block.

### Example 95

A method of coding video data, the method comprising: conditionally coding an end-run flag when a number of occurrences of a palette run syntax element in a block is greater than or equal to a palette size, wherein the end-run flag indicates if the current run of a run-length syntax element is at an end of the block; and coding video data in accordance with the end-run flag.

### Example 96

A method of coding video data, the method comprising: coding an end-run flag using context-based entropy coding, wherein the end-run flag indicates if a current run of a run-length syntax element is at an end of a block; and selecting a context for the end-run flag based whether a number of occurrences of a palette run syntax element in the block is greater than or equal to a palette size.

### Example 97

A method of coding video data, the method comprising: conditionally coding an end-run flag based on whether an INDEX palette coding mode has been used at least once for each valid palette index, wherein the end-run flag indicates if the current run of a run-length syntax element is at an end of the block; and coding video data in accordance with the end-run flag.

### Example 98

A method of coding video data, the method comprising: coding an end-run flag using context-based entropy coding, wherein the end-run flag indicates if a current run of a run-length syntax element is at an end of a block; and selecting a context for the end-run flag based on whether an INDEX palette coding mode has been used at least once for each valid palette index.

### Example 99

An apparatus comprising: a video memory configured to store video data; and a video encoder in communication with the video memory and configured to perform any combination of examples 82-98.

### Example 100

An apparatus comprising: a video memory configured to store video data; and a video decoder in communication with the video memory and configured to perform any combination of examples 82-98.

### Example 101

An apparatus comprising: means for performing any combination of examples 82-98.

### Example 102

A non-transitory computer-readable storage medium storing instructions that, when executed, cause one or more processors of a device configured to encode video data to perform any combination of examples 82-98.

### Example 103

A non-transitory computer-readable storage medium storing instructions that, when executed, cause one or more processors of a device configured to decode video data to perform any combination of examples 82-98.

### Example 104

A video encoding device comprising: a memory storing instructions; and one or more processors which upon execution of the instructions are configured to perform the method of any combination of examples 1-103.

### Example 105

A video decoding device comprising: a memory storing instructions; and one or more processors which upon execution of the instructions are configured to perform the method of any combination of examples 1-103.

### Example 106

A computer-readable medium having stored thereon instructions that, when executed, cause one or more processors of a video encoding device to perform the method of any combination of examples 1-103.

### Example 107

A computer-readable medium having stored thereon instructions that, when executed, cause one or more processors of a video decoding device to perform the method of any combination of examples 1-103.

### Example 108

An apparatus for encoding video data comprising a means for performing any combination of examples 1-103.

### Example 109

An apparatus for decoding video data comprising a means for performing any combination of examples 1-103.

It should be understood that all of the techniques described herein may be used individually or in combination. For example, video encoder 20 and/or one or more components thereof and video decoder 30 and/or one or more components thereof may perform the techniques described in this disclosure in any combination. This disclosure includes several signaling methods which may change depending on certain factors such as block size, palette size, slice type etc. Such variation in signaling or inferring the syntax elements may be known to the encoder and decoder a-priori or may be signaled explicitly in the video parameter set (VPS), sequence parameter set (SPS), picture parameter set (PPS), slice header, at a tile level or elsewhere.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially. In addition, while certain aspects of this disclosure are described as being performed by a single module or unit for purposes of clarity, it should be understood that the techniques of this disclosure may be performed by a combination of units or modules associated with a video coder.

Certain aspects of this disclosure have been described with respect to the developing HEVC standard for purposes of illustration. However, the techniques described in this disclosure may be useful for other video coding processes, including other standard or proprietary video coding processes not yet developed.

The techniques described above may be performed by video encoder 20 (FIGS. 1 and 2) and/or video decoder 30 (FIGS. 1 and 3), both of which may be generally referred to as a video coder. Likewise, video coding may refer to video encoding or video decoding, as applicable.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

While particular combinations of various aspects of the techniques are described above, these combinations are provided merely to illustrate examples of the techniques described in this disclosure. Accordingly, the techniques of this disclosure should not be limited to these example combinations and may encompass any conceivable combination of the various aspects of the techniques described in this disclosure.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data using palette mode, the method comprising:
receiving, from an encoded video bitstream, a first syntax element defining a value indicative of a scan order;
receiving, from the encoded video bitstream, a second syntax element defining a value indicative of a swap operation; and
reconstructing a palette block from a plurality of palette index values based on the value of the second syntax element indicative of the swap operation.

2. The method of claim 1, wherein the palette block is a coding unit or a prediction unit.

3. The method of claim 1, wherein reconstructing the palette block includes swapping, according to the swap operation, a first palette index value of the plurality of palette index values having a first scan position with a second palette index value of the plurality of palette index values having a second scan position before processing the plurality of palette index values according to the scan order.

4. The method of claim 3, wherein reconstructing the palette block includes swapping, according to the swap operation, each palette index value of the plurality of palette index values with another palette index value of the plurality of palette index values before processing the plurality of palette index values according to the scan order, wherein swapping each palette index value of the plurality of palette index values with another palette index value of the plurality of palette index values includes swapping the first palette index value of the plurality of palette index values having the first scan position with the second palette index value of the plurality of palette index values having the second scan position.

5. The method of claim 1, wherein reconstructing the palette block includes swapping, according to the swap operation, a first palette index value of the plurality of palette index values having a first scan position with a second palette index value of the plurality of palette index values having a second scan position after processing the plurality of palette index values according to the scan order.

6. The method of claim 5, wherein reconstructing the palette block includes swapping, according to the swap operation, each palette index value of the plurality of palette index values with another palette index value of the plurality of palette index values after processing the plurality of palette index values according to the scan order, wherein swapping each palette index value of the plurality of palette index values with another palette index value of the plurality of palette index values includes swapping the first palette index value of the plurality of palette index values having the first scan position with the second palette index value of the plurality of palette index values having the second scan position.

7. The method of claim 1, wherein the first syntax element includes palette_transpose_flag and the second syntax element includes palette_flip_flag.

8. A device for decoding video data using palette mode, the device comprising:
a memory; and
a video decoder configured to:
receive, from an encoded video bitstream, a first syntax element defining a value indicative of a scan order;
receive, from the encoded video bitstream, a second syntax element defining a value indicative of a swap operation;
reconstruct a palette block from a plurality of palette index values based on the value of the second syntax element indicative of the swap operation; and
store the palette block in the memory.

9. The device of claim 8, wherein the palette block is a coding unit or a prediction unit.

10. The device of claim 8, wherein the video decoder is configured to reconstruct the palette block by being configured to swap, according to the swap operation, a first palette index value of the plurality of palette index values having a first scan position with a second palette index value of the plurality of palette index values having a second scan position before processing the plurality of palette index values according to the scan order.

11. The device of claim 10, wherein the video decoder is configured to reconstruct the palette block by being configured to swap, according to the swap operation, each palette index value of the plurality of palette index values with another palette index value of the plurality of palette index values before processing the plurality of palette index values according to the scan order, wherein the video decoder being configured to swap each palette index value of the plurality of palette index values with another palette index value of the plurality of palette index values includes the video decoder being configured to swap the first palette index value of the plurality of palette index values having the first scan position with the second palette index value of the plurality of palette index values having the second scan position.

12. The device of claim 8, wherein the video decoder is configured to reconstruct the palette block by being configured to swap, according to the swap operation, a first palette index value of the plurality of palette index values having a first scan position with a second palette index value of the plurality of palette index values having a second scan position after processing the plurality of palette index values according to the scan order.

13. The device of claim 12, wherein the video decoder is configured to reconstruct the palette block by being configured to swap, according to the swap operation, each palette index value of the plurality of palette index values with another palette index value of the plurality of palette index values after processing the plurality of palette index values according to the scan order, wherein the video decoder being configured to swap each palette index value of the plurality of palette index values with another palette index value of the plurality of palette index values includes the video decoder being configured to swap the first palette index value of the plurality of palette index values having the first scan position with the second palette index value of the plurality of palette index values having the second scan position.

14. The device of claim 8, wherein the first syntax element includes palette_transpose_flag and the second syntax element includes palette_flip_flag.

15. A method of encoding a palette block of video data having a plurality of palette index values using palette mode, the method comprising:
generating a first syntax element defining a value indicative of a scan order;
generating a second syntax element defining a value indicative of a swap operation; and
encoding the plurality of palette index values based on the value of the second syntax element indicative of the swap operation.

16. The method of claim 15, wherein encoding the plurality of palette index values based on the value of the second syntax element indicative of the swap operation includes swapping, according to the swap operation, a first palette index value of the plurality of palette index values having a first scan position with a second palette index value of the plurality of palette index values having a second scan position before processing the plurality of palette index values according to the scan order.

17. The method of claim 16, wherein encoding the plurality of palette index values based on the value of the second syntax element indicative of the swap operation includes swapping, according to the swap operation, each palette index value of the plurality of palette index values with another palette index value of the plurality of palette index values before processing the plurality of palette index values according to the scan order, wherein swapping each palette index value of the plurality of palette index values with another palette index value of the plurality of palette index values includes swapping the first palette index value of the plurality of palette index values having the first scan position with the second palette index value of the plurality of palette index values having the second scan position.

18. The method of claim 15, wherein encoding the plurality of palette index values based on the value of the second syntax element indicative of the swap operation includes swapping, according to the swap operation, a first palette index value of the plurality of palette index values having a first scan position with a second palette index value of the plurality of palette index values having a second scan position after processing the plurality of palette index values according to the scan order.

19. The method of claim 18, wherein encoding the plurality of palette index values based on the value of the second syntax element indicative of the swap operation includes swapping, according to the swap operation, each palette index value of the plurality of palette index values with another palette index value of the plurality of palette index values after processing the plurality of palette index values according to the scan order, wherein swapping each palette index value of the plurality of palette index values with another palette index value of the plurality of palette index values includes swapping the first palette index value of the plurality of palette index values having the first scan position with the second palette index value of the plurality of palette index values having the second scan position.

20. The method of claim 15, wherein the first syntax element includes palette_transpose_flag and the second syntax element includes palette_flip_flag.
